(19) United States
(12) Patent Application Publication
(10) Pub. No.: US 2007/0219280 A1
(43) Pub. Date: Sep. 20, 2007

(54) Organometallic Complex Structure and Production Method Thereof; and Functional Film, Functional Composite Material, Functional Structure and Adsorption and Desorption Sensor Using the Organometallic Complex Structure

(75) Inventors: Susumu Kitagawa, Kyoto (JP); Takashi Uemura, Kyoto (JP)

Correspondence Address: BUCHANAN, INGERSOLL & ROONEY PC, POST OFFICE BOX 1404, ALEXANDRIA, VA, 22313-1404, US

(73) Assignee: KYOTO UNIVERSITY, Kyoto-shi, Kyoto (JP)

(21) Appl. No.: 10/593,098

(22) PCT Filed: Sep. 9, 2004
(86) PCT No.: PCT/JP04/13114

§ 371 Date: Oct. 24, 2006

(30) Foreign Application Priority Data
Mar. 15, 2004 (JP) 2004-072708

(51) Int. Cl. C08K 3/08

(52) U.S. Cl. 520/1

(57) ABSTRACT

An organometallic complex structure or the like is provided that is suitable for a novel material, composite material, film, structure, detecting unit such as a sensor, etc. in a variety of regions such as electronics, magnetics, adsorption, and catalyst. An organometallic complex structure including a metal ion, an organic compound capable of binding to the metal ion, a pillar ligand capable of binding to the metal ion, and an organic polymer capable of interacting with the metal ion, wherein the organometallic complex structure has a porous structure. Preferably, in one aspect, the molar ratio of the metal ion, the organic compound, and the pillar ligand is 2:2:1, in another aspect, an organometallic complex expressed by formula: {[M₂Y₂L]₂·xH₂0}ₙ, where M represents the metal ion, Y represents the organic compound, L represents the pillar ligand, and x and n represent an integer, is included, and in another aspect, the porous structure is a structure such that pores with a specific size are arrayed regularly.

### TECHNICAL FIELD

The present invention relates to an organometallic complex structure in which structure at a molecular level is controlled and nanosized functional pores that enables adsorption and desorption, or arrangement of guest are arrayed regularly, and production method thereof; and relates to a functional film, functional composite material, functional structure and adsorption and desorption sensor using the organometallic complex structure.

### BACKGROUND ART

Previously, activated carbons and zeolites were representative of functional materials having pores, however, due to rapid progress of crystal engineering, in recent years, attention has been paid to nanosized pores of a coordination polymer that is constructed by a metal and a bridging ligand (See, Non-Patent Literatures 1 and 2). A variety of useful applications are expected for this coordination polymer, and efficient construction methods are desired. This coordination polymer has a structure in which metal complexes are assembled at the nano-level. Its efficient construction methods have not been provided yet.

It is possible to obtain the coordination polymer, for example, by a method in which a metal ion and an organic ligand that are materials of the metal complex constituting the structure are mixed. In this case, however, solid crystal is formed rapidly, causing a problem that crystal growth (e.g. size, dimension) of the coordination polymer cannot be controlled, and that desired crystals of the coordination polymer cannot be obtained.

Separately, recently, an attention has been paid to the development of e.g. a sensor, novel material that utilize adsorption, arrangement, etc. at a molecular level, however, practicable technique has not been provided yet.

[Non-Patent Literature 1] M. Kondo, S. Kitagawa, et. al: Angew. Chem. Int. Ed., 36, 1725 (1997)

[Non-Patent Literature 2] S. Noro, S. Kitagawa, M. Kondo and K. Seki: Angew. Chem. Int. Ed., 39, 2082 (2000)

### DISCLOSURE OF INVENTION

An object of the invention is to solve conventional problems mentioned above and to achieve the following objects. Specifically, an object of the invention is to provide an organometallic complex structure which can be appropriately utilized as e.g. a novel material, composite material, membrane, and structure in a variety of regions such as electronics, magnetics, adsorption, catalyst, luminescence, medicine, carrier, and analysis, which guest can be, for example, adsorbed to, desorbed from, or arranged in effectively or selectively, and which is extremely highly functional without the structure being destroyed during performing such functions, and efficient production method thereof that can control its crystalline properties (size, dimension, etc.) easily; and to provide a functional film, functional composite material, functional structure that can be appropriately utilized in a variety of regions such as electronics, magnetics, adsorption, catalyst, luminescence, medicine, carrier, and analysis by using the organometallic complex structure and that are highly functional and/or high performance, and a adsorption and desorption sensor by which detection or analysis is possible at a molecular level and that is high-performance.

Means for solving the above-mentioned problems are as follows. Specifically,

<1> An organometallic complex structure including a metal ion, an organic compound capable of binding to the metal ion, a pillar ligand capable of binding to the metal ion, and an organic polymer capable of interacting with the metal ion, wherein the organometallic complex structure has a porous structure. In the organometallic complex structure, guest is adsorbed in, desorbed from, or arrayed in the pores in the porous structure. As a result, the organometallic complex structure is suitable as e.g. a novel material, composite material, membrane, and structure in a variety of regions such as electronics, magnetics, adsorption, catalyst, luminescence, medicine, carrier, and analysis, in addition, as a detecting unit such as a sensor. In the organometallic complex structure, the porous structure constructed by the metal ions, organic compounds, pillar ligands forms a composite with the organic polymer, and morphology and size are controlled. Consequently, the orientation of pores in the porous structure is controlled.

<2> The organometallic complex structure according to the <1>, wherein the molar ratio of the metal ion, the organic compound, and the pillar ligand, that is, metal ion: organic compound: pillar ligand, is one of 2:2:1 and 1:2:1. In the organometallic complex structure, by the metal ion, the organic compound, and the pillar ligand that are contained in a molar ratio of one of 2:2:1 and 1:2:1, pores in the porous structure are arrayed regularly and formed. When two molecules of the pillar ligands, for example, interact with each other through π-π stacking, and the pillar ligand can be extended upon removal of the π-π stacking, the molar ratio is 1:2:1.

<3> The organometallic complex structure according to one of the <1> and <2>, wherein the organometallic complex structure is expressed by one of formulae: {[M₂Y₂L]₂·xH₂O}ₙ and {[MY₂L]₂·xH₂O}ₙ, where M represents the metal ion, Y represents the organic compound, L represents the pillar ligand, and x and n represent an integer. The organometallic complex structure is a crystal hydrate. When two molecules of the pillar ligands, for example, interact with each other through π-π stacking, and the pillar ligand can be extended upon removal of the π-π stacking, the organometallic complex structure is expressed by formula: {[MY₂L]₂·xH₂O}ₙ.

<4> The organometallic complex structure according to any one of the <1> to <3>, wherein the porous structure is a structure such that pores with a specific size are arrayed regularly. In the organometallic complex structure, guest can be adsorbed in, desorbed from, or arranged in the pores with a specific size selectively. As a result, the organometallic complex structure is suitable as e.g. a novel material, composite material, membrane, and structure in a variety of regions such as electronics, magnetics, adsorption, catalyst, luminescence, medicine, carrier, and analysis, in addition, as a detecting unit such as a sensor.

<5> The organometallic complex structure according to any one of the <1> to <4>, wherein the porous structure is a structure such that two organometallic layers adjacent to each other of two or more organometallic layers formed by the metal ion and the organic compound are linked by the pillar ligands, wherein the pillar ligands are arranged with the length direction thereof being a substantially same direction and spaced substantially at specific intervals. In the organometallic complex structure, a plurality of the organometallic layers are arranged substantially in parallel with each other and two organometallic layers adjacent to each other are linked by the pillar ligands arranged in such a way that the length direction thereof is substantially oriented in an intersecting direction or substantially perpendicular direction with respect to the layer plane of these. As a result, a plurality of pores formed by the organometallic layer and pillar ligand are arrayed regularly.

<6> The organometallic complex structure according to the <5>, wherein in the porous structure, a plurality of pores have a substantially specific size seen from the direction substantially parallel to the arrayed direction of the pillar ligands, wherein the pore is formed by two pillar ligands adjacent to each other, two another pillar ligands adjacent to the two pillar ligands and positioned substantially in parallel thereto, and a region of the organometallic layer, the region being surround by these four pillar ligands. In the organometallic complex structure, the pores open having a substantially specific size lo seen from the direction substantially parallel to the arrayed direction of the pillar ligands. Thus, guest is adsorbed in and desorbed from, or arrayed in the pores from this direction.

<7> The organometallic complex structure according to any one of the <1> to <6>, wherein in the porous structure, the size of the pores is capable of being changed by a stimulus. In the organometallic complex structure, even guest with slightly larger diameter than that of the pore is adsorbed in and desorbed from, or arrayed in the pores.

<8> The organometallic complex structure according to any one of the <4> to <7>, wherein the organometallic layer includes a structure in which organometallic layer structural units formed by the metal ion and the organic compound are bridged, wherein in the organometallic layer, each of metal ions in two organometallic layer structural units is bridged by an organic compound of one organometallic layer structural unit and an organic compound of the other organometallic layer structural unit, the one and the other organometallic layer structural units each being different from the two organometallic layer structural units, to thereby form a metal ion dimer unit. In the organometallic complex structure, organometallic layer structural units are linked with each other in the metal ion dimer unit, bridged and polymerized, resulting in the formation of the organometallic layer.

<9> The organometallic complex structure according to any one of the <5> to <8>, wherein the orientation of one pillar ligand along the length direction, the one pillar ligand being bound to one metal ion in the metal ion dimer unit of the organometallic layer and the orientation of the other pillar ligand along the length direction, the other pillar ligand being bound to the other metal ion are different from each other. In the organometallic complex structure, for example, a second organometallic layer, positioned on one surface side of a first organometallic layer, and the first organometallic layer are linked by the one pillar ligand, and the third organometallic layer, positioned on the other surface side of the first organometallic layer, and the first organometallic layer are linked by the other pillar ligand.

<10> The organometallic complex structure according to any one of the <1> to <9>, wherein the metal ion is selected from Group 6 element to Group 12 element in the long form of a periodic table. In the organometallic complex structure, the organic compound and the pillar ligand are bound to the metal ion.

<11> The organometallic complex structure according to any one of the <1> to <10>, wherein the metal ion is a divalent atom. In the organometallic complex structure, the organic compound and the pillar ligand are bound to the divalent metal ion.

<12> The organometallic complex structure according to any one of the <1> to <11>, wherein the metal ion is selected from a copper ion, a rhodium ion, a chromium ion, a molybdenum ion, a palladium ion and a zinc ion. In the organometallic complex structure, the organic compound and the pillar ligand are bound to these metal ions.

<13> The organometallic complex structure according to any one of the <1> to <12>, wherein the organic compound is a bridging ligand capable of bridging to the metal ion. In the organometallic complex structure, the organic compound can coordinate to one metal ion, and besides can bridge the other metal ion.

<14> The organometallic complex structure according to any one of the <1> to <13>, wherein the organic compound is selected from a heteroaromatic compound and a derivative thereof. In the organometallic complex structure, the heteroatom of the organic compound can coordinate to one metal ion, and besides the portion having bridging properties of the organic compound can bridge the other metal ion.

<15> The organometallic complex structure according to any one of the <1> to <14>, wherein the organic compound is pyrazine-2,3-dicarboxylate. In the organometallic complex structure, the nitrogen atom and one oxygen atom of the pyrazine-2,3-dicarboxylate can coordinate to one metal ion, and besides the other oxygen atom of the pyrazine-2,3-dicarboxylate can bridge the other metal ion.

<16> The organometallic complex structure according to any one of the <1> to <15>, wherein the affinities of the organic compound and the pillar ligand are selected from hydrophilic and hydrophobic. In the organometallic complex structure, if the affinities of the organic compound and the pillar ligand are both hydrophilic, the affinity of the pore that is formed by these also becomes hydrophilic, and if the affinities are both hydrophobic, the affinity of the pore also becomes hydrophobic. In addition, if the affinities of the organic compound and the pillar ligand are different from each other, the affinity of the pore is depending on the region, i.e., the region close to the organic compound and the region distant from the organic compound show an affinity opposite to each other.

<17> The organometallic complex structure according to any one of the <1> to <16>, wherein the affinity of the organic compound and the pillar ligand is one of hydrophilic and hydrophobic to each other. In the organometallic complex structure, if the affinities of the organic compound and the pillar ligand are both hydrophilic, the affinity of the pore that is formed by these also becomes hydrophilic, and if the affinities are both hydrophobic, the affinity of the pore also becomes hydrophobic.

<18> The organometallic complex structure according to any one of the <1> to <17>, wherein the pillar ligand includes a heteroaromatic compound. In the organometallic complex structure, the heteroaromatic compound of the pillar ligand interacts with the metal ion.

<19> The organometallic complex structure according to any one of the <1> to <18>, wherein the pillar ligand includes heteroatoms at both ends thereof. In the organometallic complex structure, the heteroatom positioned at one end interacts with one metal ion, and the heteroatom positioned at the other end interacts with the other metal ion.

<20> The organometallic complex structure according to any one of the <1> to <19>, wherein the pillar ligand is selected from pyrazine, bipyridine, azopyridine, dipyridylethylene, dipyridylbenzene, dipyridylglycol, dipyridylethane and dipyridylpropane. In the organometallic complex structure, the nitrogen atom positioned at one end in these pillar ligands interacts with one metal ion, and the nitrogen atom positioned at the other end interacts with the other metal ion.

<21> The organometallic complex structure according to any one of the <1> to <20>, wherein the pillar ligand is at least one of capable of being expanded and contracted, and capable of being transformed. In the organometallic complex structure, since the pillar ligand is at least one of capable of being expanded and contracted, and capable of being transformed, the structure of the organometallic complex structure is flexible, and the size of the pores in the organometallic complex structure can be increased or decreased.

<22> The organometallic complex structure according to any one of the <1> to <21>, wherein the pillar ligand is at least one of capable of being expanded and contracted by a stimulus, and capable of being transformed by a stimulus. In the organometallic complex structure, since the pillar ligand is at least one of capable of being expanded and contracted, and capable of being transformed, the structure of the organometallic complex structure is flexible, and, for example, upon adsorption of the guest with slightly larger diameter than that of the pore, in the pore in the organometallic complex structure, the size of the pores is increased due to the stimulus upon adsorption of the guest.

<23> The organometallic complex structure according to any one of the <1> to <22>, wherein the pillar ligand includes two or more organic polymers, wherein at least two organic polymers of the two or more organic polymers interact with each other through π-π stacking. In the organometallic complex structure, the pillar ligand includes two or more organic polymers and at least two organic polymers of the two or more organic polymers interact with each other through π-π stacking. Thus, the structure of the organometallic complex structure is flexible, and, for example, upon adsorption of the guest with slightly larger diameter than that of the pore, in the pore in the organometallic complex structure, π-π stacking between the two organic polymers is removed due to the stimulus upon adsorption of the guest and the size of the pores is increased. When the guest is desorbed from the pore, the two organic polymers again interact with each other through π-π stacking due to the stimulus upon desorption of the guest, and it will result that the size of the pores returns to its former size.

<24> The organometallic complex structure according to the <1> to <23>, wherein the organic polymer is selected from an ionic polymer. In the organometallic complex structure, by the interaction of the ionic polymer with the metal ion during construction of the organometallic complex structure, the reactivity of the metal ion with the organic compound and/or the pillar ligand is changed, leading to the control of its crystalline properties (size, dimension, etc.).

<25> The organometallic complex structure according to the <24>, wherein the ionic polymer is selected from a cationic polymer, an anionic polymer and an amphoteric polymer. In the organometallic complex structure, these ionic polymers interact with the metal ion during construction of the organometallic complex structure and the reactivity of the metal ion with the organic compound and/or the pillar ligand is changed, leading to the control of its crystalline properties (size, dimension, etc.).

<26> The organometallic complex structure according to one of the <24> and <25>, wherein the ionic polymer is polyvinylsulfonic acid, sodium salt. In the organometallic complex structure, the polyvinylsulfonic acid, sodium salt interacts with the metal ion during construction of the organometallic complex structure and the reactivity of the metal ion with the organic compound and/or the pillar ligand is changed, leading to the control of its crystalline properties (size, dimension, etc.).

<27> The organometallic complex structure according to any one of the <1> to <26>, which is one of a plate-like crystal, a granular crystal, and a wire-like crystal.

<28> The organometallic complex structure according to any one of the <1> to <27>, which is used for at least one of adsorption and desorption of a guest, and arrangement of a guest.

<29> The organometallic complex structure according to any one of the <1> to <28>, which is used for at least one of selective adsorption and desorption of a guest, and selective arrangement of a guest.

<30> A functional film including the organometallic complex structure of any one of the <1> to <29>. The functional film has a function to allow guest to, for example, be adsorbed and desorbed, or arranged.

<31> A functional composite material including the organometallic complex structure of any one of the <1> to <29>, and a guest, wherein the guest is one of adsorbed and arranged in pores of the organometallic complex structure. To the functional composite material, function attributable to the regular array of the guests or function attributable to the desorption of the guest is added.

<32> A functional structure including a substrate, and the organometallic complex structure of any one of the <1> to <29> on the substrate. In the functional structure, the organometallic complex structure is arranged on the substrate in a state exhibiting a strong preferential orientation, and the functional structure is highly-functional.

<33> The functional structure according to the <32>, further including a guest, wherein the guest is one of adsorbed and arranged in pores of the organometallic complex structure. To the functional structure, function attributable to the regular array of the guests or function attributable to the desorption of the guest is added.

<34> An adsorption and desorption sensor including the organometallic complex structure of any one of the <1> to <29>, and a detecting unit configured to detect adsorption of a guest in pores in the organometallic complex structure. In the adsorption and desorption sensor, the guest as a detecting target is adsorbed in and desorbed from the pores in the organometallic complex structure, which is detected by the detecting unit. As a result, the presence of the guest as the detecting target is detected.

<35> A method for producing an organometallic complex structure including mixing a metal ion, an organic compound capable of binding to the metal ion, a pillar ligand capable of binding to the metal ion, and an organic polymer capable of interacting with the metal ion. In the method for producing an organometallic complex structure, the organometallic complex can be obtained effectively and in a state where its crystalline properties (size, dimension, etc.) are controlled. In the organometallic complex structure, the porous structure constructed by the metal ion, organic compound, and the pillar ligand forms a composite with the organic polymer, by which morphology and size are controlled. Consequently, only application of stimulus such as a small pressure allows the orientation of pores in the porous structure to be controlled in a certain direction easily.

<36> The method for producing an organometallic complex structure according to the <35>, wherein the mixing is carried out at temperatures of 50° C. or lower. In the method for producing an organometallic complex structure, simply by mixing raw materials at normal temperature without heating to a high temperature, the organometallic complex can be obtained effectively.

<37> The method for producing an organometallic complex structure according to one of the <35> and <36>, wherein the mixing is carried out by stirring. In the method for producing an organometallic complex structure, simply by stirring raw materials, the organometallic complex can be obtained effectively.

<38> The method for producing an organometallic complex structure according to any one of the <35> to <38>, wherein the amount of organic polymer to be mixed at the mixing satisfies: (mole of the organic polymer/mole of the metal atom)≧20. In the method for producing an organometallic complex structure, when the molar ratio of the organic polymer and the metal ion is set to 20 or more, a uniform nanowire crystal of organometallic complex structure with a certain diameter (100 nm to 400 nm) can be obtained efficiently.

<39> The method for producing an organometallic complex structure according to any one of the <35> to <38>, wherein after the mixing, an obtained crystal or a powder is subjected to a preferential orientation treatment, wherein in the preferential orientation treatment, pressure is applied to the obtained crystal or the powder from one direction.

By performing the preferential orientation treatment, even if the orientation of pores in the organometallic complex structure is random, it can be selectively controlled so that the orientation effectively faces in a specific direction.

<40> The method for producing an organometallic complex structure according to any one of the <35> to <38>, wherein after the mixing, an obtained crystal or a powder is subjected to a preferential orientation treatment, wherein in the preferential orientation treatment, pressure is applied to the obtained crystal or the powder by pushing the obtained crystal or the powder with fingers from one direction. When the preferential orientation treatment is carried out. by pressure with fingers, even if the orientation of pores in the organometallic complex structure is random, it can be selectively controlled so that the orientation effectively faces in a specific direction.

<41> The method for producing an organometallic complex structure according to any one of the <35> to <40>, wherein the metal ion is mixed as a compound containing the metal ion. In the method for producing an organometallic complex structure, supply of raw material of the metal ion and dissolution in a reaction system is easy.

### BRIEF DESCRIPTION OF DRAWINGS

FIG. 1 shows an example of the reaction formula of the organometallic complex structure of the invention.

FIG. 2 is a conceptual diagram showing an example of the pore of the organometallic complex structure of the invention.

FIG. 3 shows a specific example of the pore of the organometallic complex structure of the invention.

FIG. 4 is a conceptual diagram showing an example of the pore of the organometallic complex structure of the invention (porous structure CPL-1).

FIG. 5 is a conceptual diagram showing an example of the pore of the organometallic complex structure of the invention (porous structures CPL's-1 to 5).

FIG. 6 is a conceptual diagram showing an example of the organometallic layer of the organometallic complex structure of the invention and its linked state.

FIG. 7 shows an example of the pillar ligand of the organometallic complex structure of the invention.

FIG. 8A is a conceptual diagram showing an example of the structure of the case where pillar ligand in the organometallic complex structure of the invention can be extended.

FIG. 8B is a graph showing the amount of adsorption of methane in and desorption of methane from the pores in the organometallic complex structure of the invention, and the gas pressure of methane.

FIG. 9A is a conceptual diagram showing an example of the structure of the case where pillar ligand in the organometallic complex structure of the invention can be extended.

FIG. 9B is a graph showing the amount of adsorption of methanol in and desorption of methanol from the pores in the organometallic complex structure of the invention, and the pressure of methanol.

FIG. 10 is a graph showing data of adsorption and desorption of H₂O molecules by the organometallic complex structure of the invention (FIG. 3).

FIG. 11 is a graph showing data of adsorption and desorption of H₂O molecules by the organometallic complex structure of the invention (FIG. 3).

FIG. 12 is a graph showing data of adsorption and desorption of methanol molecules by the organometallic complex structure of the invention (FIG. 3).

FIG. 13 is a SEM electron microscope photograph (Magnification: 1,500) of the crystal of organometallic complex structure which was obtained after mixing with stirring for one day, wherein the added amount of the poly(vinylsulfonic acid, sodium salt) (PVSA) as the organic polymer to the metal ion was changed to 50 equivalent.

FIG. 14 is a TEM electron micrograph of the crystal of organometallic complex structure which was obtained after mixing with stirring for one day, wherein the added amount of the poly(vinylsulfonic acid, sodium salt) (PVSA) as the organic polymer to the metal ion was changed to 50 equivalent.

FIG. 15 is a SEM electron microscope photograph (Magnification: 850) of the crystal of the organometallic complex structure obtained in the case where the amount of the poly(vinylsulfonic acid, sodium salt) (PVSA), as the organic polymer, added to the metal ion was 1 equivalent.

FIG. 16 is a SEM electron microscope photograph (Magnification: 1,600) of the crystal of the organometallic complex structure obtained in the case where the amount of the poly(vinylsulfonic acid, sodium salt) (PVSA), as the organic polymer, added to the metal ion was 10 equivalent.

FIG. 17 is a SEM electron microscope photograph (Magnification: 900) of the crystal of the organometallic complex structure obtained in the case where the amount of the poly(vinylsulfonic acid, sodium salt) (PVSA), as the organic polymer, added to the metal ion was 15 equivalent.

FIG. 18 is a SEM electron microscope photograph (Magnification: 1,500) of the crystal of the organometallic complex structure obtained in the case where the amount of the poly(vinylsulfonic acid, sodium salt) (PVSA), as the organic polymer, added to the metal ion was 20 equivalent.

FIG. 19 is a SEM electron microscope photograph (Magnification: 7,000) of the crystal of the organometallic complex structure obtained in the case where the amount of the poly(vinylsulfonic acid, sodium salt) (PVSA), as the organic polymer, added to the metal ion was 0 equivalent (Comparative Example).

FIG. 20 is a SEM electron microscope photograph (Magnification: 4,000) of the crystal of the organometallic complex structure obtained after mixing with stirring for one day, wherein the added amount of the poly(vinylsulfonic acid, sodium salt) (PVSA) as the organic polymer to the metal ion was 0 equivalent (Comparative Example).

FIG. 21 shows a scheme for producing the organometallic complex structure having the above-mentioned porous structure CPL-1 (FIG. 4).

FIG. 22 is a chart of the result of the analysis in which the differences of the crystalline properties of organometallic complex structures obtained by adding different amount of poly(vinylsulfonic acid, sodium salt) (PVSA) as the organic polymer (0 equivalent, 1 equivalent, 10 equivalent, 15 equivalent, 20 equivalent, 30 equivalent) to the metal ion and then mixing without stirring were compared by analyzing XRPD patterns.

FIG. 23 is a chart of the result of the analysis in which the differences of the crystalline properties of organometallic complex structures obtained by adding different amount of poly(vinylsulfonic acid, sodium salt) (PVSA) as the organic polymer (0 equivalent, 1 equivalent, 10 equivalent, 15 equivalent, 20 equivalent, 30 equivalent) to the metal ion and then mixing with stirring for one day were compared by analyzing XRPD patterns.

FIG. 24 is a chart of the result of the analysis in which the crystal of organometallic complex structure was analyzed by a near-infrared absorption spectral pattern, which organometallic complex structure was obtained after mixing with stirring for one day, wherein the added amount of the poly(vinylsulfonic acid, sodium salt) (PVSA) as the organic polymer to the metal ion was changed to 50 equivalent.

FIG. 25 is a chart of the result of the analysis in which the crystal of organometallic complex structure was analyzed by a XRPD pattern, which organometallic complex structure was obtained after mixing with stirring for one day, wherein the added amount of the poly(vinylsulfonic acid, sodium salt) (PVSA) as the organic polymer to the metal ion was changed to 50 equivalent.

FIG. 26 is SEM electron microscope photographs (magnification of left photograph: 11,000 and magnification of right photograph: 9,000) of the crystal of the organometallic complex structure obtained when 20 equivalent poly(vinylsulfonic acid, sodium salt) (PVSA) as the organic polymer was added to the metal ion.

FIG. 27 is a SEM electron microscope photograph (Magnification: 8,000) of the crystal of the organometallic complex structure obtained when 10 equivalent poly(vinylsulfonic acid, sodium salt) (PVSA) as the organic polymer was added to the metal ion.

### BEST MODE FOR CARRYING OUT THE INVENTION

(Organometallic Complex Structure)

The organometallic complex structure of the invention comprises a metal ion, an organic compound capable of binding to the metal ion, a pillar ligand capable of binding to the metal ion, and an organic polymer capable of interacting with the metal ion, and may further comprise additional components appropriately selected on an as-needed basis; and has a porous structure.

In the organometallic complex structure, the molar ratio of the metal ion, the organic compound, and the pillar ligand (metal ion:organic compound:pillar ligand) is preferably one of approximately 2:2:1 and approximately 1:2:1.

If the molar ratio is one of approximately 2:2:1 and approximately 1:2:1, in the porous structure, the pillar ligands bind to an organometallic layer in an intersecting direction or substantially perpendicular direction with respect to the layer plane of the organometallic layer formed by the metal ion and the organic compound. As a result, a number of pores having a substantially uniform size, shape, etc. and arrayed regularly can be formed by the organometallic layer and the pillar ligand. When two molecules of the pillar ligands, for example, interact with each other through π-π stacking, and the pillar ligand can be extended upon removal of the π-π stacking, the molar ratio is approximately 1:2:1.

The molar ratio of the metal ion, the organic compound, and the pillar ligand (metal ion:organic compound:pillar ligand) can be analyzed by any method without limitation, including appropriately selected methods known in the art. Suitable examples of the method include X-ray structural analysis methods and elemental analysis methods.

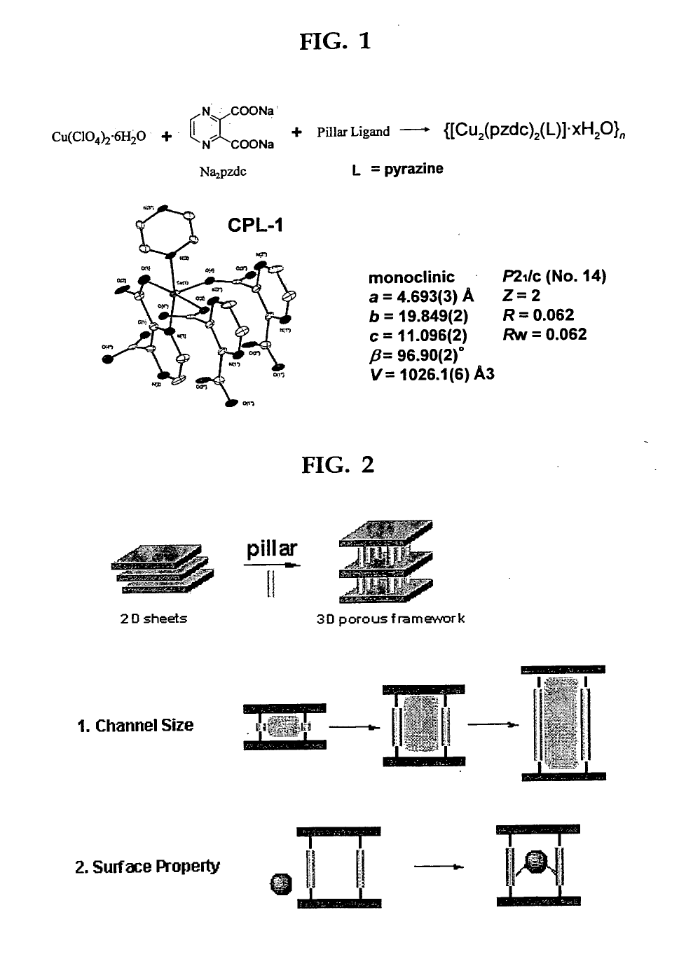

Preferably, the organometallic complex structure comprises a crystal hydrate expressed by the formula: {[M₂Y₂L]₂·xH₂O}ₙ, where M represents the metal ion mentioned later, Y represents the organic compound mentioned later, L represents the pillar ligand mentioned later, and x and n represent an integer. For example, as the reaction formula shown in the top of FIG. 1, in the case where copper (Cu) is used as the metal ion (for example, using Cu(CLO₄)₂·6H₂O as a raw material), pyrazine-2,3-dicarboxylate (pydc) is used as the organic compound (for example, using pyrazine-2,3-sodium dicarboxylate as a raw material), and pyrazine (pyz) is used as the pillar ligand, the organometallic complex structure is expressed by the formula:
{[Cu₂(pydc)₂(pyz)]·xH₂O}ₙ.

When the L is a pillar ligand capable of being extended, wherein at least two organic polymers of two or more organic polymers interact with each other, for example, through π-π stacking, the organometallic complex structure preferably comprises a crystal hydrate expressed by the formula: {[MY₂L]₂·xH₂O}ₙ, where M, Y, L, x and n are as described above.

When the organometallic complex structure comprises the crystal hydrate expressed by the foregoing formula, the porous structure, in which a number of pores with substantially uniform size, shape, etc. are arrayed regularly, is present in the organometallic complex, and desired guests can be, for example, adsorbed in, desorbed from, or arranged in these pores. As a result, the organometallic complex structure may be appropriately utilized as e.g. a novel material, composite material, membrane, and structure in a variety of regions such as electronics, magnetics, adsorption, catalyst, luminescence, medicine, carrier, and analysis.

The composition formula of the crystal of the organometallic complex can be determined by any method without limitation, including appropriately selected methods known in the art. Suitable examples thereof include X-ray structural analysis methods and elemental analysis methods.

-Porous Structure-

The porous structure is not particularly limited and can be appropriately selected depending on the intended purpose. For example, the porous structure preferably has a structure in which pores with certain size are arrayed regularly.

In this case, in the organometallic complex structure, desired guests can be, for example, adsorbed in, desorbed from, or arranged in the pores with a specific size arbitrarily or selectively.

The guest is not particularly limited and can be appropriately selected depending on the application or intended purpose; examples thereof include atoms and molecules. Examples of the atom include metal ions. Examples of the molecule include gas molecules, inorganic compound molecules, and organic compound molecules. These may be used singly or in combination.

When a metal ion or the like is selected as the guest, for example, the organometallic complex structure in which the guest is adsorbed or arranged can be suitably used in such fields as electronics, magnetics, catalyst, optics, medicine, and drug delivery system. When a gas molecule or the like is selected as the guest, for example, the organometallic complex structure can be suitably used in e.g. a gas occlusion and gas sensor.

Specific structure of the porous structure is not particularly limited and can be appropriately selected depending on the intended purpose. For example, such structure is preferable that two adjacent organic metals among two or more organic metals formed by the metal ion and organic compound are linked with each other by pillar ligands arranged with the length direction thereof being a substantially same direction and spaced substantially at specific intervals.

FIG. 2 shows a conceptual diagram of such specific structure. For example, the organometallic layers (layers shown as 2D sheets in FIG. 2) and the pillar ligands (rod-shaped molecules shown as a pillar in FIG. 2) constitute three-dimensional porous structure (structure shown as 3D porous framework in FIG. 2) through the connection of the organometallic layers by the pillar ligands.

Whether the porous structure is present in the organometallic complex is analyzed by any method without limitation, including appropriately selected methods known in the art. Suitable examples thereof include a X-ray diffraction method, gas absorption method and thermoanalytical method (weight, amount of heat).

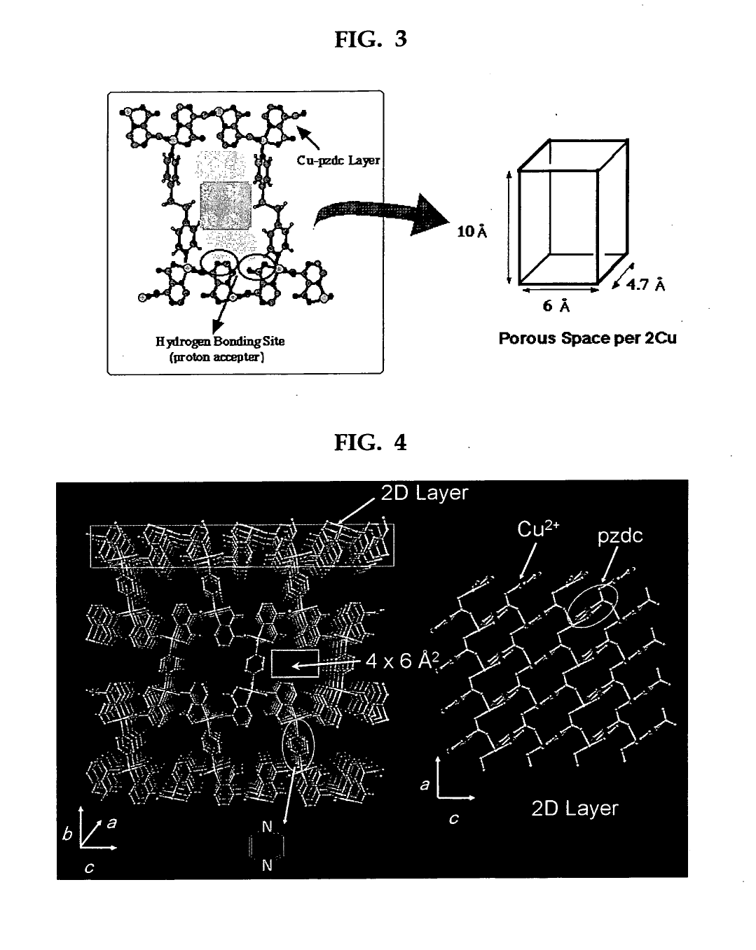

When the porous structure is the specific structure, a plurality of the organometallic layers are arranged substantially in parallel with each other and two organometallic layers adjacent to each other are linked by the pillar ligands arranged in such a way that pillar ligands stand in a direction substantially perpendicular to the layer plane of these (See, the structural unit shown in the middle and on the bottom of FIG. 2). As a result, pores formed, surrounded by the organometallic layers and the pillar ligands are arrayed regularly. The minimum unit of the pores is the space formed by the adjacent four pillar ligands and the region of the organometallic layer, surround by the pillar ligands (See, the structure shown as 3D porous framework in FIG. 2 and rectangular parallelepiped structure shown as Porous Space per 2Cu in the right of FIG. 3).

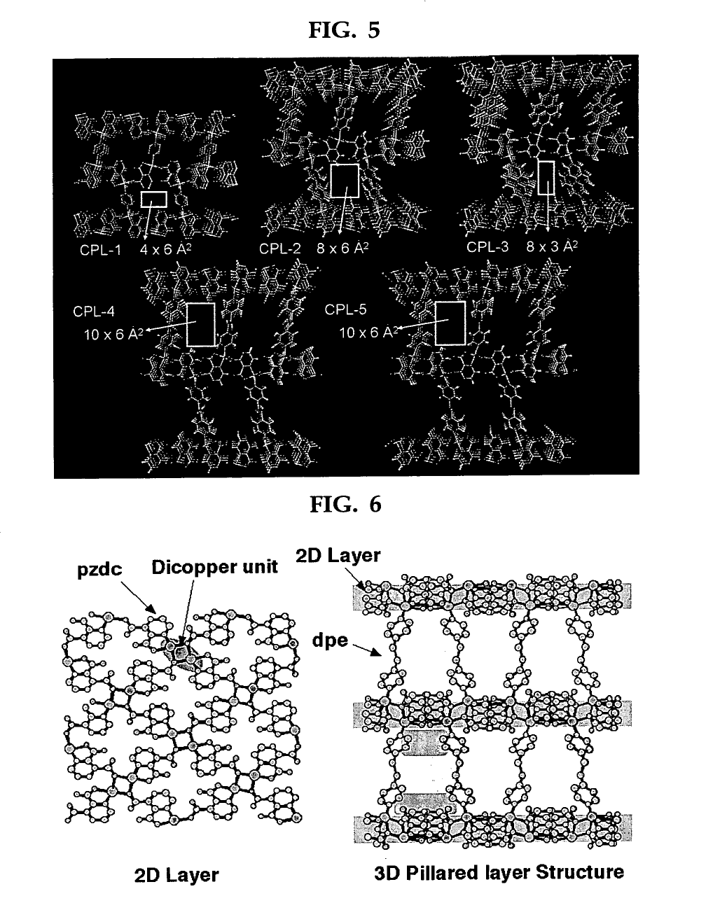

When the porous structure has the structure of specific examples shown in the left of FIG. 3 and in the right of FIG. 6, the length direction of pillar ligands is oriented in a direction substantially perpendicular to the layer plane of the organometallic layer formed by copper (Cu) and pyrazine-2,3-dicarboxylate (pzdc) and the pillar ligands are arrayed regularly. The space formed by the adjacent four pillar ligands and the region of the organometallic layer, surround by the pillar ligands, is defined as the unit of the pore.

When the porous structure has such specific structure, desired guests can be adsorbed in and desorbed from, or arrayed in the pores in the porous structure arbitrarily or selectively, and regularly. Thus, the organometallic complex structure having the porous structure can be suitably used in a variety of fields as a molecular (guest) adsorbent, molecular (guest) releasing agent (supplying agent), molecule (guest) arranging means, composite material where molecules (guests) are arrayed regularly.

In the porous structure, plural pores preferably have a substantially specific size seen from the direction substantially parallel to the arrayed direction of the pillar ligands, which pores are formed by two pillar ligands adjacent to each other, two another pillar ligands adjacent to the two pillar ligands and positioned substantially in parallel thereto, and a region of the organometallic layer, which region is surround by these four pillar ligands.

As the specific example of the size of the pores in the porous structure, the pores of specific examples CPLs-1 to -5 shown in FIG. 5 have the following specific size as seen from the direction substantially parallel to the arrayed direction of the pillar ligands. In any of these specific examples, the metal ion is copper (Cu) and the organic compound is pyrazine-2,3-dicarboxylate (pydc). Specifically, in the case of the specific example CPL-1 shown in FIG. 4 and on the left side of the upper figures in FIG. 5, the pillar ligand is pyrazine (pyz) and the size of pores is about 4×6 square angstrom (0.4×0.6 nm²), in the case of the specific example CPL-2 shown in the middle of the upper figures in FIG. 5, the pillar ligand is bipyridine (bpy) and the size of pores is about 8×6 square angstrom (0.8×0.6 nm²), in the case of the specific example CPL-3 shown on the right side of the upper figures in FIG. 5, the pillar ligand is diazapyrene (pyre) and the size of pores is about 8×3 square angstrom (0.8×0.3 nm²), in the case of the specific example CPL-4 shown on the left side of the lower figures in FIG. 5, the pillar ligand is azopyridine (azpy) and the size of pores is about 10×6 square angstrom (1×0.6 nm²), and in the case of the specific example CPL-5 shown on the right side of the lower figures in FIG. 5, the pillar ligand is dipyridylethylene (dpe) and the size of pores is about 10×6 square angstrom (1×0.6 nm²).

The size of pores can be measured by any method without limitation, including appropriately selected methods known in the art. Suitable examples thereof include a X-ray diffraction method and gas adsorption method.

If the size of pores in the porous structure of the organometallic complex structure is a substantially specific size seen from the direction substantially parallel to the arrayed direction of the pillar ligands, the guest can be selectively adsorbed and desorbed or arranged.

In the porous structure, the size of the pores may be invariable or may be variable. When the size of the pores can be changed by a stimulus, even if the organometallic complex structure is a rigid crystal, the inside of the pores of the crystal becomes a flexible structure. Thus, the organometallic complex structure becomes highly-functional. Specifically, in this case, in the organometallic complex structure, even guest with slightly larger diameter than that of the pore, the guest can be adsorbed in and desorbed from, or arranged in the pores. Thus, by detecting the change of the size of the pores by means of a known method, adsorption and desorption of the guest can be detected. Therefore, the organometallic complex structure can be suitably used for the application such as a sensor.

The organometallic layer is not particularly limited and can be appropriately selected depending on the intended purpose. For example, those formed by the metal ion and the organic compound are suitable, and those comprising a plurality of organometallic layer structural units formed by one metal ion and one organic compound (the organometallic layer structural units being polymerized or bridged) are suitable.

In this case, it is preferable that each of metal ions in two organometallic layer structural units is bridged by the organic compound of another one organometallic layer structural unit and the organic compound of another the other organometallic layer structural unit, each organometallic layer structural unit being different from the two organometallic layer structural units, thereby forming a metal ion dimer unit (See, Dicopper unit of the network in the left of FIG. 6). When the combined unit is formed in the organometallic layer of the organometallic complex structure, the metal ion of one organometallic layer structural unit and the organic compound of the other organometallic layer structural unit (See, pyrazine-2,3-dicarboxylate (pzdc) in the left of FIG. 6) are bridged (polymerized) to form a network. Consequently, organometallic layer with a desired area can be formed.

Preferably, the orientation of a first pillar ligand along the length direction, which is bound to one metal ion of the two metal ions in the metal ion dimer unit of the organometallic layer and the orientation of a second pillar ligand along the length direction, which is bound to the other metal ion are substantially opposite. In this case, in the organometallic complex structure, a second organometallic layer, positioned on one surface side of a first organometallic layer (See, 2D Layer in FIGS. 4 and 6 and layers positioned in parallel thereto), and the first organometallic layer are linked by the one pillar ligands, and other organometallic layer, positioned on the other surface side of the one organometallic layer, and the one organometallic layer are linked by the other pillar ligands. Thus, the organometallic layers (See, 2D Layer in FIGS. 5 and 6) can be stacked while the organometallic layers are linked by the pillar ligands of which length direction is oriented in a same direction and which are arrayed regularly, and besides, the size of the pore, formed by the organometallic layers and the pillar ligands can be substantially uniform.

-Metal Ion (Metal Atom)-

The metal ion (metal atom) is not particularly limited and can be appropriately selected depending on the intended purpose; examples thereof include ions (atom) of element selected from Group 6 element to Group 12 element in the long form of the periodic table.

These may be used singly or in combination. Among these, divalent or more metal ions are preferable for enabling the formation of the metal ion dimer unit, divalent metal ions are more preferable for forming ordered organometallic layers, a metal ion selected from a copper ion, rhodium ion, chromium ion, molybdenum ion, palladium ion and zinc ion is further preferable, and a copper ion is most preferable since it is available easily.

Compounds such as salts containing the metal ion may be used as a raw material of the metal ion at the time of production of the organometallic complex structure.

Whether the metal ion is contained in the organometallic complex structure or not can be analyzed by any method without limitation, including appropriately selected methods known in the art. Suitable examples thereof include an absorption spectrum measurement and elemental analysis.

-Organic Compound-

The organic compound is not particularly limited and can be appropriately selected depending on the intended purpose; suitable examples thereof include bridging ligands capable of bridging the metal ion. When the organic compound is the bridging ligand, the metal ion and the organic compound can form the metal complex layer.

Suitable specific examples of the organic compound include compounds having a cyclic structure for forming a relatively stable and high-strength organometallic layer.

Examples of the compound having a cyclic structure include alicyclic compounds and derivatives thereof, aromatic compounds and derivatives thereof, and heteroaromatic compounds and derivatives thereof. These may be used singly or in combination. Among these, those selected from heteroaromatic compounds and derivatives thereof are preferable. In this case, in the organometallic complex structure, a heteroatom can coordinate to one metal ion, and besides the portion having bridging properties of the organic compound can bridge the other metal ion.

When the organic compound is the heterocyclic compounds and derivatives thereof, suitable specific examples include pyridine-2,3-dicarboxylate (pzdc).

These may be used singly or in combination. Among these, pyridine-2,3-dicarboxylate (pzdc) is preferable. In this case, a nitrogen atom can coordinate to one metal ion, and besides a carboxylate moiety of the pyridine-2,3-dicarboxylate (pzdc) can bridge other metal ion.

Whether the organic compound is contained in the organometallic complex structure or not can be analyzed by any method without limitation, including appropriately selected methods known in the art. Suitable examples thereof include an elemental analysis and X-ray diffraction method.

-Pillar Ligand-

The pillar ligand is not particularly limited and can be appropriately selected depending on the intended purpose. For example, compounds having a cyclic structure are suitable for forming stable pores between the organometallic layers. These may be used singly or in combination.

Examples of the compound having a cyclic structure include alicyclic compounds and derivatives thereof, aromatic compounds and derivatives thereof, and heteroaromatic compounds and derivatives thereof. Among these, those selected from heteroaromatic compounds and derivatives thereof are preferable. When the pillar ligand is selected from the heteroaromatic compounds and derivatives thereof, the heteroaromatic compound or the like interacts with or bridges the metal ion to form a three-dimensional structure, resulting in the construction of the porous structure.

In addition, the pillar ligand is preferably compounds having heteroatoms at both ends thereof. When the pillar ligand is the heterocyclic compound and derivatives thereof, the pillar ligand is preferably such compounds that heteroatoms of the heteroaromatic compound are present at both ends of the pillar ligand. When the pillar ligand is compounds having the heteroatoms at both ends thereof, the heteroatom positioned at one end interacts with or bridges one metal ion, and the heteroatom positioned at the other end interacts with or bridges the other metal ion to form a three-dimensional structure, resulting in the construction of the porous structure.

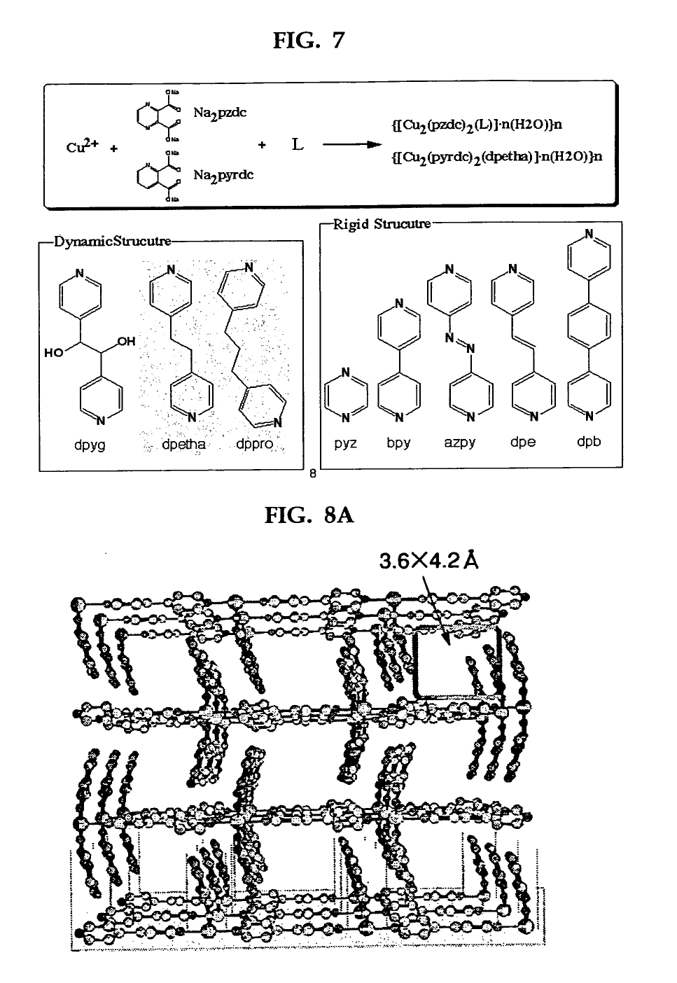

Specific examples of the pillar ligand include pyrazine (pyz on the bottom of FIG. 7), bipyridine (bpy on the bottom of FIG. 7), azopyridine (azpy on the bottom of FIG. 7), dipyridylethylene (dpe on the bottom of FIG. 7), dipyridylbenzene (dpb on the bottom of FIG. 7), dipyridylglycol (dpyg on the bottom of FIG. 7), dipyridylethane (dpetha on the bottom of FIG. 7), dipyridylpropane (dppro on the bottom of FIG. 7), dihydroxybenzoic acid (dhba), and ethylene glycol to which pyridines are bound at both end thereof (dpyg).

When the pillar ligand is the pyrazine (pyz on the bottom of FIG. 7), the organometallic complex structure has the structure of the specific example CPL-1 shown on the left side of the upper figures in FIG. 5, and is suitably obtained as a plate crystal. When the pillar ligand is bipyridine (bpy on the bottom of FIG. 7), the organometallic complex structure has the structure of the specific example CPL-2 shown in the middle of the upper figures in FIG. 5, and is suitably obtained as a wire-like crystal.

These may be used singly or in combination. When the pillar ligand is these, the nitrogen atom positioned at one end in these pillar ligands interacts with or bridges one metal ion, and the nitrogen atom positioned at the other end interacts with or bridges the other metal ion to form a three-dimensional structure, resulting in the construction of the porous structure.

In the invention, as shown in the middle of FIG. 2, by appropriately changing the length of molecule (length along the length direction) of the pillar ligand, the size (volume, height, depth) can be changed arbitrarily. By appropriately selecting the pillar ligand depending on the intended purpose, for example, according to the type, size, etc. of the guest to be adsorbed in and desorbed from the pores, the porous structure can be designed such that pores with a desired size are arrayed regularly. Likewise, the size (volume, width) of the pores can be changed arbitrarily by changing the molecular structure, the length of molecule, or the like of the organic compound in the organometallic layer. By appropriately selecting the organic compound depending on the intended purpose, for example, according to the type, size, etc. of the guest to be adsorbed in and desorbed from the pores, the porous structure can be designed such that pores with a desired size are arrayed regularly. Besides, in the organometallic complex structure, the porous structure constructed by the metal ions, organic compounds, pillar ligands forms a composite with the organic polymer, and morphology and size are controlled. Consequently, only application of stimulus such as a small pressure allows the orientation of pores in the porous structure to be controlled in a certain direction easily.

When the organometallic complex structure is designed using as the pillar ligand, for example, two or more compounds having different lengths of their molecules (length along the length direction), two organometallic layers can be linked by the pillar ligands with shorter length of molecule, and another two organometallic layers can be linked by the pillar ligands with longer length of molecule, enabling the interlayer distance of the metal layers in the organometallic complex structure to be changed or altered depending on the number of types of the pillar ligand used.

Normally, the length of the pillar ligand is invariable, but the pillar ligand may be at least one of capable of being expanded and contracted, and capable of being transformed.

In the case where the pillar ligand is at least one of capable of being expanded and contracted, and capable of being transformed, although the organometallic complex structure is a rigid crystal, the inside structure thereof is flexible, and the size of the pores in the organometallic complex structure can be increased or decreased. Thus, high-functional and/or high-performance organometallic complex structure can be achieved. Among the pillar ligands at least one of capable of being expanded, and capable of being transformed, those at least one of capable of being expanded by a stimulus, and capable of being transformed by a stimulus are preferable. The stimulus is not particularly limited and can be appropriately selected depending on the intended purpose; suitable examples thereof include the pressure given by the guest when the guest has been adsorbed in and desorbed from the pores, and intermolecular force.

In the case where the pillar ligand is at least one of capable of being expanded by a stimulus, and capable of being transformed by a stimulus, upon adsorption of the guest with slightly larger diameter than that of the pore, in the pore, the pillar ligand is at least one of expanded and transformed due to the stimulus upon adsorption of the guest (welding pressure or suppress strength applied to the pillar ligand). As a result, the size of the pores is increased. Conversely, when the guest is desorbed from the pore, the pillar ligand returns to its former state from stretched state due to the stimulus upon desorption of the guest (removal of welding pressure or suppress strength applied to the pillar ligand). As a result, the size of the pores returns to its former size.

As a specific example of the pillar ligand capable of stretching, those are suitable that comprises two or more organic polymers where at least two organic polymers of the two or more organic polymers interact with each other, for example, through π-π stacking or hydrogen bond.

In this case, retain or removal of the interaction between the pillar ligands such as the π-π stacking and hydrogen bond makes the structure of the pores in the organometallic complex structure flexible, and the size (volume, height, depth) of the pores becomes variable. When the guest with slightly larger diameter than that of the pore is adsorbed in the pore, for example, the interaction between the two organic polymers such as the π-π stacking and hydrogen bond is removed and the pillar ligand is extended, resulting in the increase of the size (volume, height, depth) of the pores. On the other hand, when the guest is desorbed from the pore, the two organic polymers again interact with each other through, for example, π-π stacking and hydrogen bond, and it will result that the length of the pillar ligand returns to its former length and that the size of the pores returns to its former size.

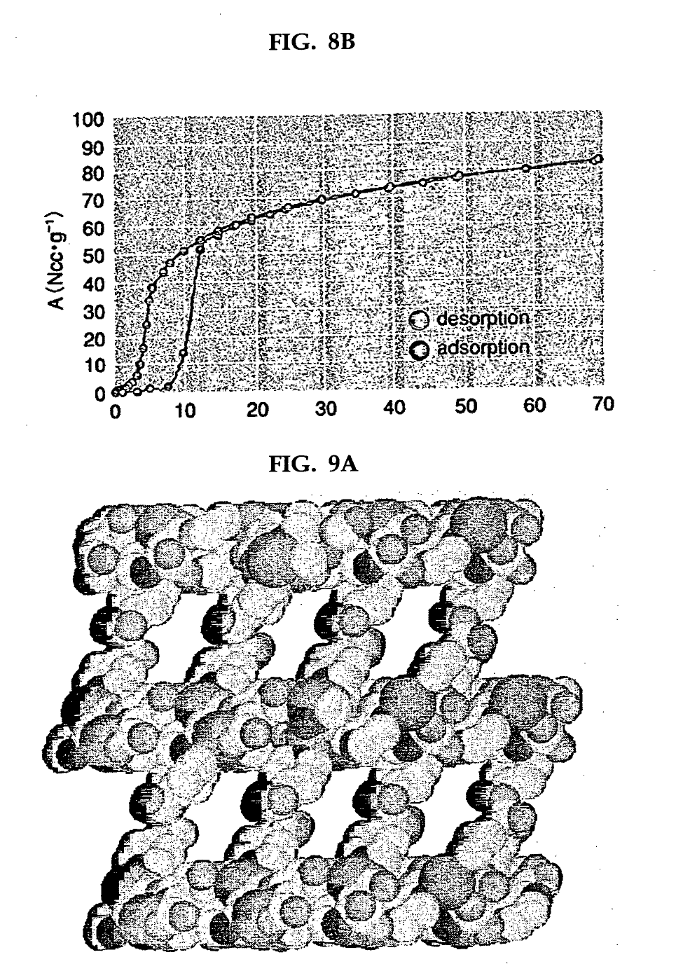

FIGS. 8A and 8B show an example of the case where the pillar ligands in the organometallic complex structure interact with each other through π-π stacking of two more of organic polymers. Here, the organometallic layer is formed by copper (II) as the metal ion and 4,4′-bipyridine. Considering two adjacent layers of the organometallic layers, one end of dihydroxybenzoic acid (dhba) as the pillar ligand is bond to one organometallic layer of the two adjacent layers, but the other end of the dihydroxybenzoic acid (dhba) is not bond to the other organometallic layer. Meanwhile, one end of another dihydroxybenzoic acid (dhba) different from the above-mentioned dihydroxybenzoic acid (dhba) is bond to the other organometallic layer, but the other end of another dihydroxybenzoic acid (dhba) is not bound to the one organometallic layer. Between the one organometallic layer and the other organometallic layer, the dihydroxybenzoic acid (dhba) bond to the one organometallic layer and the dihydroxybenzoic acid (dhba) bond to the other organometallic layer adopt a nested structure, and π electron of one heteroaromatic ring structure is stacked with π electron of the other heteroaromatic ring structure. In the organometallic complex structure shown in FIG. 8A, the pillar ligand is comprised of the two dihydroxybenzoic acid (dhba) interacting with each other through π-π stacking, and is apparently one structure. Application of stimulus to the pores, for example, application of stimulus, due to the adsorption of guests with slightly larger diameter than that of the pores, in the pores enables this pillar ligand to remove the π-π stacking interaction and to extend. As a result, the size of the pores becomes variable. The organometallic complex structure is expressed by [Cu(dhba)₂(4,4′-bpy)].

In fact, when methane (gas) is allowed to adsorb to and desorb from the organometallic complex structure shown in FIG. 8A at a temperature of 298 K while gradually increasing gas pressure, a graph as shown in FIG. 8B is obtained. Specifically, initially, while increasing gas pressure, methane (gas) is allowed to adsorb to the organometallic complex structure. Since the size of the pores in the organometallic complex structure is smaller than the methane molecules, the methane molecules are not adsorbed in the pores at a low gas pressure, less than 8 atm. However, when the gas pressure is increased to 8 atm or more, the π-π stacking interaction between the two dihydroxybenzoic acid (dhba) constituting the pillar ligand is removed by the stimulus of welding pressure or suppress strength to the pore by the methane, and the pillar ligand extends. As a result, the size of the pores increases to the size capable of adsorbing the methane, and molecules of methane are adsorbed in the pores rapidly. In contrast, when gas pressure is lowered gradually, the methane gradually desorbs from the pores, however, different from the case of the adsorption, the methane does not desorb rapidly even if the gas pressure decreased to 8 atm. FIG. 8B shows the relation between the adsorption amount of the methane in the pores and the gas pressure of methane. In FIG. 8B, the trend of adsorption of the methane does not correspond with the trend of desorption, indicating hysteresis. This hysteresis attributes to the change of the entire crystal structure. Specifically, the pillar ligand has a structure capable of being extended, and the size of the pores in the organometallic complex structure has changed, resulting in the change of the entire crystal structure.

Suitable specific examples of the pillar ligand capable of being transformed include those having soft molecule capable of being transformed in a portion of their structure. The soft molecule is not particularly limited and can be appropriately selected depending on the intended purpose; examples thereof include chain molecules. Specific examples thereof include ethylene glycol and propylene glycol. These may be used singly or in combination. Among these, ethylene glycol is preferable. Suitable specific examples of the pillar ligand capable of being transformed include ethylene glycol to which pyridines are bound at both end thereof (dpyg).

In this case, the soft molecule capable of being transformed of the pillar ligand makes the structure of the pore in the organometallic complex structure flexible, and the size (volume, height, depth) of the pores becomes variable. For example, when the guest with slightly larger diameter than that of the pore is adsorbed in the pore, by the stimulus caused by the adsorption of the guest, the soft molecule capable of being transformed changes from a distorted structure to a stretched structure. As a result, the pillar ligand extends, resulting in the increase of the size (volume, height, depth) of the pores. On the other hand, when the guest is desorbed from the pore, the soft molecule capable of being transformed changes from the stretched structure to the distorted structure. As a result, the length of the pillar ligand returns to its former length, and the size of the pores returns to its former size.

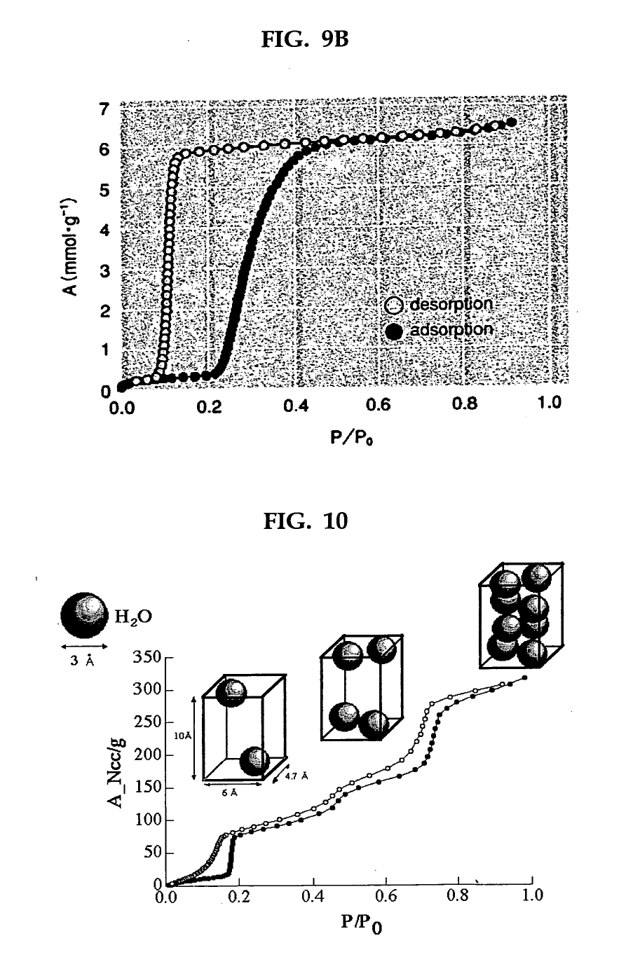

FIGS. 9A and 9B show an example of the case where the pillar ligand comprises in a portion of its structure a soft molecule capable of being transformed. Here, the organometallic layer is formed of copper (II) as the metal ion and 4,4′-bipyridine as the organic compound. Two adjacent organometallic layers are linked by the ethylene glycol to which pyridines are bound at both end thereof (dpyg) serving as the pillar ligand. In the organometallic complex structure shown in FIG. 9A, the pillar ligand comprises in a portion thereof ethylene glycol capable of being transformed. Thus, application of stimulus to the pores in the organometallic complex structure, for example, application of stimulus, due to the adsorption of guests with slightly larger diameter than that of the pores, in the pores allows the molecule of the ethylene glycol extends. As a result, the size of the pores becomes variable.

In fact, when methanol vapour is allowed to adsorb to and desorb from the organometallic complex structure shown in FIG. 9A at a temperature of 298 K while gradually increasing pressure (P/P₀), a graph as shown in FIG. 9B is obtained. Specifically, initially, while increasing pressure (P/P₀), methanol vapour is allowed to adsorb to the organometallic complex structure. Since the size of the pores in the organometallic complex structure is smaller than the methanol molecules, the methanol molecules are not adsorbed in the pores at a low pressure (P/P₀), less than 0.2. However, when the pressure (P/P₀) is increased to 0.2 or more, ethylene glycol constituting the pillar ligand changes from a distorted structure to a stretched structure by the stimulus of welding pressure or suppress strength to the pore by the methanol, and the pillar ligand extends. As a result, the size of the pores increases to the size capable of adsorbing the methanol, and molecules of methanol are adsorbed in the pores rapidly. In contrast, when pressure (P/P₀) is lowered gradually, the methanol gradually desorbs from the pores, however, different from the case of the adsorption, the methanol does not desorb rapidly even if the pressure (P/P₀) decreased to 0.2. FIG. 9B shows the relation between the adsorption amount of the methanol in the pores and the pressure (P/P₀) of methanol. In FIG. 9B, the trend of adsorption of the methanol does not correspond with the trend of desorption, indicating hysteresis. This hysteresis attributes to the change of the entire crystal structure. Specifically, the pillar ligand has a transformable structure, and the size of the pores in the organometallic complex structure has changed, resulting in the change of the entire crystal structure.

Whether the pillar ligan is contained in the organometallic complex structure or not can be analyzed by any method without limitation, including appropriately selected methods known in the art. Suitable examples thereof include an elemental analysis and X-ray diffraction method.

The affinities of the organic compound and the pillar ligand are not particularly limited, can be appropriately selected depending on the intended purpose, and may be hydrophilic or may be hydrophobic.

If the affinities of the organic compound and the pillar ligand are both hydrophilic, the affinity inside the pore that comprises these as constituents also becomes hydrophilic, and if the affinities are both hydrophobic, the affinity inside the pore also becomes hydrophobic. In addition, if the affinities of the organic compound and the pillar ligand are different from each other, the affinity inside the pore is depending on the region, i.e., the region close to the organic compound and the region distant from the organic compound show an affinity opposite to each other.

The figure shown in the left of FIG. 3 is an example of the latter case, that is, the case where there exist regions showing different affinities inside the pore. For example, as shown in the left of FIG. 3, in the organometallic layer formed by copper (Cu) as the metal ion and pyrazine-2,3-dicarboxylate (pzdc) as the organic compound (Cu-pzyc Layer in FIG. 3), hydrogen-bonding sites (proton receptor) are present, which are hydrophilic. Dipyridylethane (dpe) as the pillar ligand which links the organometallic layers facing each other is hydrophobic. Thus, in the pore formed by these, the region close to the organometallic layer shows a hydrophilic affinity and the region near the center part, distant from the organometallic layer, shows a hydrophobic affinity.

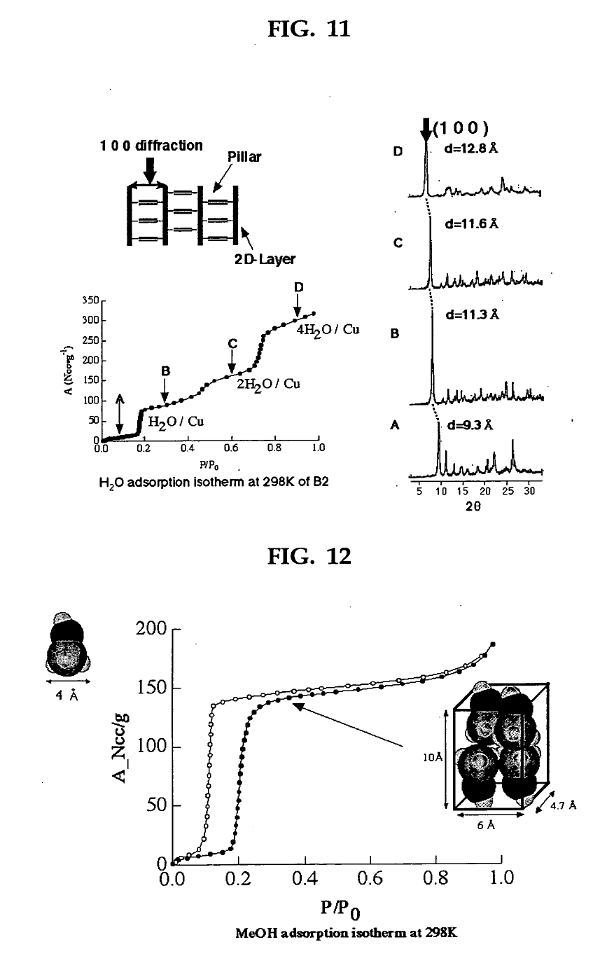

When water vapour is allowed to adsorb in and desorb from the pore shown in FIG. 3 at a temperature of 298 K while gradually increasing pressure (P/P₀), graphs as shown in FIGS. 10 and 11 are obtained. Specifically, initially, while increasing pressure (P/P₀), water molecule is allowed to adsorb to the organometallic complex structure. The water molecule is not adsorbed in the pore when pressure (P/P₀) is less than 0.19, the primary adsorption occurs at or around a pressure (P/P₀) of 0.19, the secondary adsorption occurs at or around a pressure (P/P₀) of 0.48, and the tertiary adsorption occurs at or around a pressure (P/P₀) of 0.74.

Here, while water molecule is a hydrophilic polar molecule, the pore exhibits amphoteric properties, i.e., exhibits hydrophilic properties on the organometallic layer side, and hydrophobic properties near the center part. Thus, the above-mentioned graphs indicate that upon the primary adsorption, the water molecule is adsorbed in the hydrophilic region of the pore, upon the secondary adsorption, the water molecule is adsorbed in the boundary region between the hydrophilic region and hydrophobic region of the pore, and upon the tertiary adsorption, the water molecule is adsorbed in the hydrophobic region of the pore.

When methanol vapour is allowed to adsorb in and desorb from the pore shown in FIG. 3 at a temperature of 298 K while gradually increasing pressure (P/P₀), a graph as shown in FIG. 12 is obtained. Specifically, initially, while increasing pressure (P/P₀), methanol molecule is allowed to adsorb to the organometallic complex structure. The methanol molecule is not adsorbed in the pore when pressure (P/P₀) is less than 0.2, rapid adsorption occurs at or around a pressure (P/P₀) of 0.2, and adsorption of methanol molecule in the pore is completed.

Different from the above-mentioned case of water molecule, the methanol molecule comprises a hydroxyl portion exhibiting hydrophilic properties and a methyl group portion exhibiting hydrophobic properties, and exhibits amphoteric properties. Thus, the above-mentioned graph indicates that the methanol molecules were adsorbed while arranging themselves in the pore so that upon adsorption, the hydroxyl portion exhibiting hydrophilic properties of the methanol molecule is located on the side exhibiting hydrophilic properties (organometallic layer side) in the pore, and the methyl group portion exhibiting hydrophobic properties is located near the center part exhibiting hydrophobic properties in the pore.

-Organic Polymer-

The organic polymer is not particularly limited as long as it can interact with the metal ion through coordination bond, electrostatic interaction, etc., and the organic polymer can be appropriately selected depending on the intended purpose; examples thereof include ionic polymers.

In the organometallic complex structure of the invention, by the interaction of the ionic polymer with the metal ion during construction of the organometallic complex structure, the reactivity of the metal ion with the organic compound and/or the pillar ligand is changed, leading to the control of its crystalline properties (size, dimension, etc.).

The ionic polymer is not particularly limited and can be appropriately selected depending on the intended purpose; examples thereof include cationic polymers, anionic polymers, amphoteric polymers.

Suitable examples of the cationic polymer include those having an ammonium group. Specifically, suitable examples of the cationic polymer include polydiallyldimethylammonium.

Suitable examples of the anionic polymer include those having an acrylic acid group, sulfonate group, carboxylate group, or the like.

Specifically, suitable examples of the anionic polymer include sodium polyacrylate and polysulfonic acid.

Examples of the amphoteric polymer include amphoteric surfactant and betaine compound.

These may be used singly or in combination. Among these, in terms of excellent controllability of the crystalline properties (size, dimension, etc.) of the organometallic complex structure, anionic polymer is preferable, and poly(vinylsulfonic acid, sodium salt) (PVSA) is more preferable.

The molecular mass of the organic polymer is not particularly limited and can be appropriately selected depending on the intended purpose. For example, the organic polymer has preferably about several tens of thousands of mass-average molecular mass to about several hundreds of thousands of mass-average molecular mass.

If the mass-average molecular mass of the organic polymer is within the above value, the organic polymer effectively interacts with the metal atom during construction of the organometallic complex molecule, the reactivity of the metal atom with the organic compound and/or the pillar ligand is changed. As a result, its crystalline properties (size, dimension, etc.) can be desirably controlled.

Whether the organic polymer is contained in the organometallic complex structure or not can be analyzed by any method without limitation, including appropriately selected methods known in the art. Suitable examples thereof include an elemental analysis, IR analysis method, and X-ray photoelectron spectrometry.

-Additional Component-

The additional component is not particularly limited, can be appropriately selected depending on the intended purpose and can be used as long as not adversely affecting the advantages of the invention.

-Crystal-

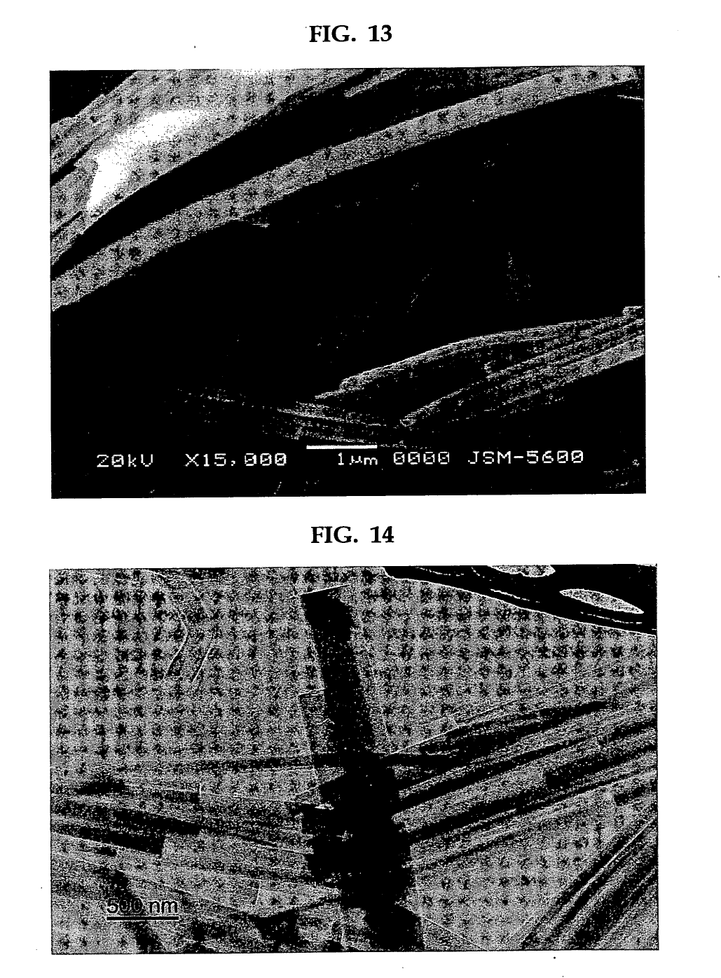

The organometallic complex structure of the invention can be obtained as a crystal. The crystal is not particularly limited and can be appropriately selected depending on the intended purpose; examples thereof include wire-like crystals shown in FIGS. 13 and 14, plate-like crystals shown in FIGS. 15 to 20, and granular crystals.

The size of the crystal is not particularly limited and can be appropriately selected depending on the intended purpose. In the case of the plate-like crystal, for example, the thickness thereof is about 0.1 μm to about 5 μm, and greatest dimension of the plate surface is about 2 μm to about 100 μm, in the case of the granular crystal, for example, the average grain diameter is about 0.1 μm to about 1 μm, and in the case of the wire-like crystal, for example, the length is about 2 μm to about 100 μm, and the diameter is about 0.1 μm to about 1 μm,

-Application-

The organometallic complex structure of the invention may be appropriately utilized as e.g. a novel material, composite material, membrane, and structure in a variety of regions such as electronics, magnetics, adsorption, catalyst, luminescence, medicine, carrier, and analysis, may be preferably utilized for efficient or selective adsorption, desorption, arrangement, etc. of guest (target), and may be preferably utilized for the functional film, functional composite material, functional structure, and adsorption and desorption sensor of the invention that will be mentioned later.

(Method for Producing an Organometallic Complex Structure)

The organometallic complex structure of the invention can be specifically advantageously produced by the method for producing an organometallic complex structure of the invention. The method for producing an organometallic complex structure of the invention will be described below.

The organometallic complex structure of the invention comprises mixing a metal ion, an organic compound capable of binding to the metal ion, a pillar ligand capable of binding to the metal ion, and an organic polymer capable of interacting with the metal ion, preferably comprises after the mixing, subjecting a generated crystal to a preferential orientation treatment, and may further comprise additional treatments appropriately selected on an as-needed basis.

-Mixing-

The temperature of the mixing is preferably 50° C. or lower, more preferably 40° C. or lower, most preferably the temperatures near room temperature since, for example, energy, cost, facilities, etc. for heating are not required, and mixing is carried out safely, thus being extremely advantageous industrially.

The period of the mixing is not particularly limited and can be appropriately selected depending on the intended purpose.

The mixing is carried out by any method without limitation and the method can be appropriately selected depending on the intended purpose; examples thereof include mixing simply by adding raw materials (mixing without stirring) and stirring (mixing with stirring). The stirring may be performed, for example, by any of airflow type, propeller type, stirrer type, and manual type, but airflow type is preferable.

When mixing, the raw materials may be added in any order without limitation, and the order can be appropriately selected depending on the intended purpose. For example, all raw materials may be added simultaneously or may be added in the selected order. For example, in one form, first, the raw material of the metal ion is added, next, the raw material of the organic polymer is added, next, the raw material of the pillar ligand is added, and last, the raw material of the organic compound is added. By the adding order of raw materials at the time of mixing, method for mixing, etc., crystalline properties (size, dimension, etc.) of the organometallic complex to be obtained can be controlled.

Preferably, the amount of raw materials to be mixed at the mixing is selected such that the molar ratio (the metal ion:the organic compound:the pillar ligand) is one of 2:2:1 and 1:2:1. Such amount is advantageous in that the waste of raw materials is decreased, and that the organometallic complex structure can be obtained in good yield. If the molar ratio of the raw material is selected so as to be 1:2:1, the resulting organometallic complex structure has a structure in which two molecules of the pillar ligands undergo π-π stacking.

The amount of the organic polymer (e.g. poly(vinylsulfonic acid, sodium salt) (PVSA)) to be mixed at the mixing is not particularly limited and can be appropriately selected depending on the shape or the like of the crystal to be obtained, or on the intended purpose. For example, in the case of specific example CPL-1 shown in the upper middle of FIG. 5, specifically, the case where the pillar ligand is pyrazine (pyz), with the increase of the amount of the organic polymer such as poly(vinylsulfonic acid, sodium salt) (PVSA) to be mixed, plate crystals can be obtained with ease and in good yield, and their crystal size (size of plate surface) increases. In the case of specific example CPL-2 shown in the upper middle of FIG. 5, specifically, the case where the pillar ligand is bipyridine (bpy), if the amount of the organic polymer such as poly(vinylsulfonic acid, sodium salt) (PVSA) to be mixed is increased, in particular, if the amount satisfies: (mole of organic polymer/mole of metal ion)≧20, a uniform nanowire crystal with a certain diameter (100 nm to 400 nm) can be obtained with ease and in good yield.

For the raw material of the metal ion at the mixing, compounds containing the metal ion such as salts of the metal ion, and like can be suitably used in terms of easy dissolution in a reaction system, etc. Examples of the salt of the metal ion include hydrochloride, sulfate, nitrate, sulfonate, and carboxylate. These may be used singly or in combination. For the organic compound, the pillar ligand, and the organic polymer, they are suitably used as a raw material.

-Preferential Orientation Treatment-

The preferential orientation treatment is a treatment performed after the mixing for giving a generated crystal a preferential orientation. The preferential orientation treatment can be preformed by any method without limitation, ad the method includes methods appropriately selected depending on the intended purpose; suitable examples thereof include a method in which after the mixing, pressure is applied to an obtained crystal or a powder from one direction.

The application of pressure to an obtained crystal or a powder from one direction after the mixing is carried out, for example, by applying a slight pressure, such as pushing the crystal or powder with a hand, finger, or the like from above.

The amount of pressure to be applied is not particularly limited and can be appropriately selected depending on the intended purpose, but the amount is such a degree that the crystal or powder is not destroyed.

By performing the above-mentioned preferential orientation treatment, the orientation of pores in the organometallic complex structure can be selectively controlled so that the orientation effectively faces in a specific direction even if initial orientation of pores is random.

-Additional Treatment-

The additional treatment is not particularly limited, can be appropriately selected depending on the intended purpose and can be perfomed as long as not adversely affecting the advantages of the invention. Examples of the additional treatment include centrifugal separation treatment, washing treatment, and drying treatment that are performed after the mixing.

The centrifugal separation treatment is not particularly limited and can be appropriately selected depending on the intended purpose; examples thereof include centrifugal separation treatments by means of a centrifuge.

The washing treatment is not particularly limited and can be appropriately selected depending on the intended purpose; examples thereof include water washing.

The drying treatment is not particularly limited and can be appropriately selected depending on the intended purpose; examples thereof include air drying and drying with a drier.

Since the method for producing an organometallic complex structure of the invention does not require heating, etc. and can produce the organometallic complex effectively simply by mixing raw materials of the organometallic complex structure at room temperature with e.g. stirring, the method is extremely energy saving and excellent in production efficiency. In the method for producing an organometallic complex structure of the invention, at the time when the organometallic complex structure is generated by the mixing, the porous structure constructed by the metal ion, organic compound, and the pillar ligand forms a composite with the organic polymer, by which morphology and size are controlled. Consequently, only application of stimulus such as a small pressure allows the orientation of pores in the porous structure to be controlled in a certain direction easily. In addition, when the preferential orientation treatment is carried out after the mixing, the orientation of pores in the organometallic complex structure can be selectively controlled so that it faces in a specific direction.

(Functional Film)

The functional film of the invention comprises the organometallic complex structure of the invention and may further comprise additional components appropriately selected on an as-needed basis.

The additional component can be used as long as not adversely affecting the function of the functional film of the invention. The additional component is not particularly limited and can be appropriately selected depending on the intended purpose; examples thereof include binder resins. Examples of the binder resin include water-soluble binders, water-dispersible binders, and water-insoluble binders.

The method for producing the functional film is not particularly limited and the functional film can be produced according to the method known in the art appropriately selected depending on the intended purpose. For example, the functional film can be produced by preparing a coating solution containing the organometallic complex structure, then applying the coating solution on a substrate, drying and performing other treatments.

The functional film of the invention can be suitably used for e.g. adsorption and desorption of guest (target), arrangement of the guest (target).

(Functional Composite Material)

The functional composite material of the invention comprises the organometallic complex structure of the invention and the guest (target), wherein the guest (target) is adsorbed or arranged in pores of the organometallic complex structure of the invention, and may further be subjected to additional treatments appropriately selected on an as-needed basis.

The adsorption or arrangement of the guest can be made by any method without limitation and the method can be appropriately selected depending on the intended purpose; examples thereof include a method in which the pressure of the guest molecules (preferably molecules in a gas state, and molecules in a supercritical fluid state) is gradually increased.

The additional treatment is not particularly limited and can be appropriately selected depending on the intended purpose; examples thereof include the above-mentioned washing treatment and above-mentioned drying treatment.

To the functional composite material of the invention, function attributable to the regular array of the guests or function attributable to the desorption of the guest is added. Thus, the functional composite material of the invention can be suitably used in a variety of regions such as electronics, magnetics, adsorption, catalyst, luminescence, medicine, carrier, and analysis.

(Functional Structure)

The functional structure of the invention comprises a substrate, and the organometallic complex structure of the invention on the substrate and may further comprise additional members or the like appropriately selected on an as-needed basis.

The material, size, shape, structure, or the like of the substrate is not particularly limited and can be appropriately selected depending on the intended purpose; suitable examples thereof include silicon substrates.

In the functional structure of the invention, the guest may be adsorbed or arranged in the pores of the organometallic complex structure.

The additional member is not particularly limited and can be appropriately selected depending on the application or the like of the functional structure.

In the functional structure of the invention, the organometallic complex structure is arranged on the substrate in a state exhibiting a strong preferential orientation. Thus, the functional structure of the invention is highly-functional and, especially, is suitably used for the analysis, etc. such as in a sensor.

In the functional structure of the invention, when the guest is adsorbed or arranged in the pores of the organometallic complex, function attributable to the adsorption or arrangement of the guest, or function attributable to the desorption of the guest is added. Thus, the functional structure of the invention can be suitably used in a variety of regions such as electronics, magnetics, adsorption, catalyst, luminescence, medicine, carrier, and analysis.

(Adsorption and Desorption Sensor)

The adsorption and desorption sensor of the invention comprises the organometallic complex structure of the invention and a detecting unit configured to detect adsorption of a guest in the pores in the organometallic complex structure, and may further comprise appropriately selected additional units.

The detecting unit is not particularly limited and can be appropriately selected depending on the intended purpose; examples thereof include a unit configured to detect adsorption of the guest to the organometallic complex structure or desorption of the guest therefrom by detecting a change in electrical resistance of the organometallic complex structure, or the like.

The additional unit is not particularly limited and can be appropriately selected depending on the application or the like.

In the adsorption and desorption sensor of the invention, other molecule as a detecting target is adsorbed in the pores in the organometallic complex structure, which is detected by the detecting unit. As a result, the presence of other molecule as the detecting target is detected.

Hereinafter, Examples of the invention will be described, which however shall not be construed as limiting the invention thereto.

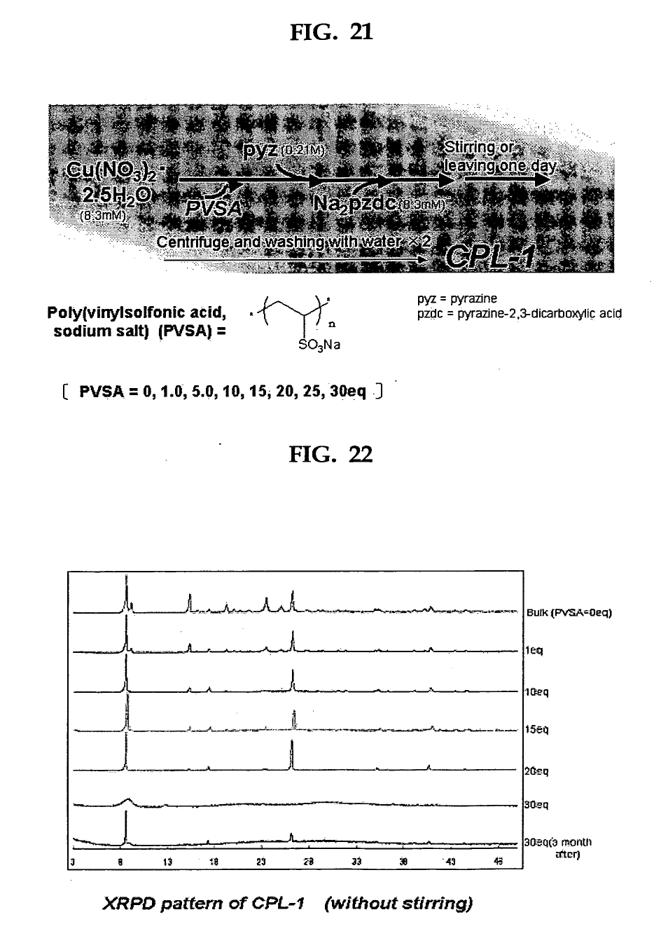

By the reaction as shown in FIG. 21, an organometallic complex structure having the above-mentioned porous structure CPL-1 (FIG. 4) was prepared at normal temperature (25° C.). Specifically, initially, in order to use copper (II) as the metal ion, 8.3 mM Cu(NO₃)₂·2.5H₂O was used as the raw material, to which was added poly(vinylsulfonic acid, sodium salt) (PVSA) (Available from Sigma-Aldrich Japan KK) as the organic polymer. Next, 0.21 M pyrazine (pyz) as the pillar ligand was added, subsequently, 8.3 mM pyrazine-2,3-dicarboxylate (pzdc) as the organic compound was added and mixed at normal temperature (25° C.), allowing to stand for one day. Then, centrifugation was performed and the crystals were washed twice to prepare the organometallic complex structure having the porous structure CPL-1 (FIG. 4).

By a X-ray diffraction method, the crystal of thus-obtained organometallic complex structure was confirmed to be expressed by the formula: {[Cu₂(pzdc)2(pyz)]₂·xH₂O}ₙ. Further, it was confirmed that the poly(vinylsulfonic acid, sodium salt) (PVSA) was contained in the organometallic complex structure by a X-ray photoelectron spectrometry and IR measurement method. In addition, the obtained organometallic complex structure was analyzed by the X-ray diffraction method and it was confirmed that the obtained organometallic complex structure had the porous structure (the above-mentioned CPL-1) as shown in FIG. 4. As a result, in the porous structure, a plurality of pores have a structure as shown in FIG. 4 seen from the direction substantially parallel to the arrayed direction of the pillar ligands, wherein the pore is formed by two pillar ligands adjacent to each other, two another pillar ligands adjacent to the two pillar ligands and positioned substantially in parallel thereto, and a region of the organometallic layer, which region is surround by these four pillar ligands. Besides, the pore had a substantially specific size seen from the direction substantially parallel to the arrayed direction of the pillar ligands, 4×6 angstrom (0.4×0.6 nm²).

FIG. 22 is a result of the analysis in which the differences of the crystalline properties of organometallic complex structures were compared by analyzing XRPD patterns. The amount of poly(vinylsulfonic acid, sodium salt) (PVSA) as the organic polymer to be added to the metal ion was changed (0 equivalent, 1 equivalent, 10 equivalent, 15 equivalent, 20 equivalent, 30 equivalent) and each organometallic complex structure was obtained after the mixing without stirring. The values on the right side in FIG. 22 mean the added amount. 30 equivalent on the bottom shows data after one-month standing. The cases where the added amount of the poly(vinylsulfonic acid, sodium salt) (PVSA) is 1 equivalent, 10 equivalent, 15 equivalent, 20 equivalent, and 30 equivalent correspond to Examples of the invention, and the case of 0 equivalent corresponds to Comparative Example of the invention. In the case where the amount of the poly(vinylsulfonic acid, sodium salt) (PVSA) added was 0 equivalent, the particle diameter of plate crystals of the obtained organometallic complex structure was 3 μm, in the case of 1 equivalent, 15 μm, in the case of 10 equivalent, 50 μm, in the case of 15 equivalent, 70 μm, and in the case of 20 equivalent, 80 μm, respectively.

In the chart of XRPD pattern, if peak of 0k0 is emphasized and other peaks become smaller, it means that the orientation of the pores in the crystal faces in a certain direction.

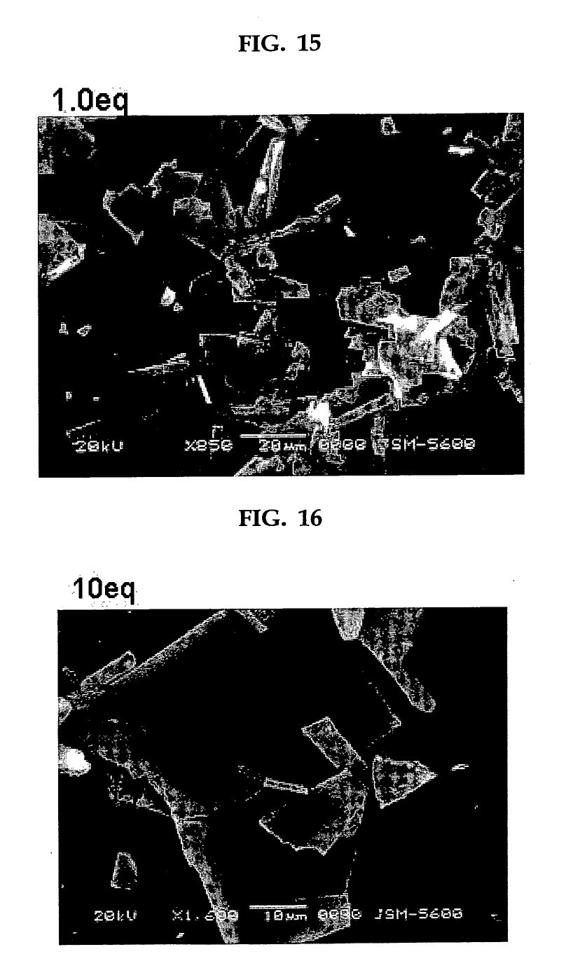

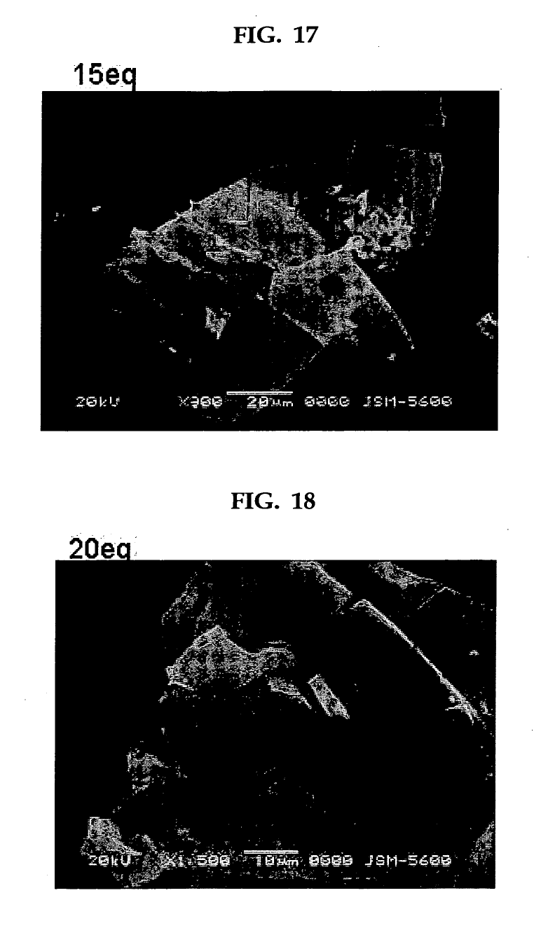

FIG. 15 is a SEM electron microscope photograph (Magnification: 850) of the crystal of the organometallic complex structure obtained in the case where the amount of the poly(vinylsulfonic acid, sodium salt) (PVSA), as the organic polymer, added to the metal ion was 1 equivalent (Example). FIG. 16 is a SEM electron microscope photograph (Magnification: 1,600) of the crystal of the organometallic complex structure obtained in the case where the amount of the poly(vinylsulfonic acid, sodium salt) (PVSA), as the organic polymer, added to the metal ion was 10 equivalent (Example). FIG. 17 is a SEM electron microscope photograph (Magnification: 900) of the crystal of the organometallic complex structure obtained in the case where the amount of the poly(vinylsulfonic acid, sodium salt) (PVSA), as the organic polymer, added to the metal ion was 15 equivalent (Example). FIG. 18 is a SEM electron microscope photograph (Magnification: 1,500) of the crystal of the organometallic complex structure obtained in the case where the amount of the poly(vinylsulfonic acid, sodium salt) (PVSA), as the organic polymer, added to the metal ion was 20 equivalent (Example). With the increase of the amount of the poly(vinylsulfonic acid, sodium salt) (PVSA) added to the metal ion, larger plate-like crystals were obtained.

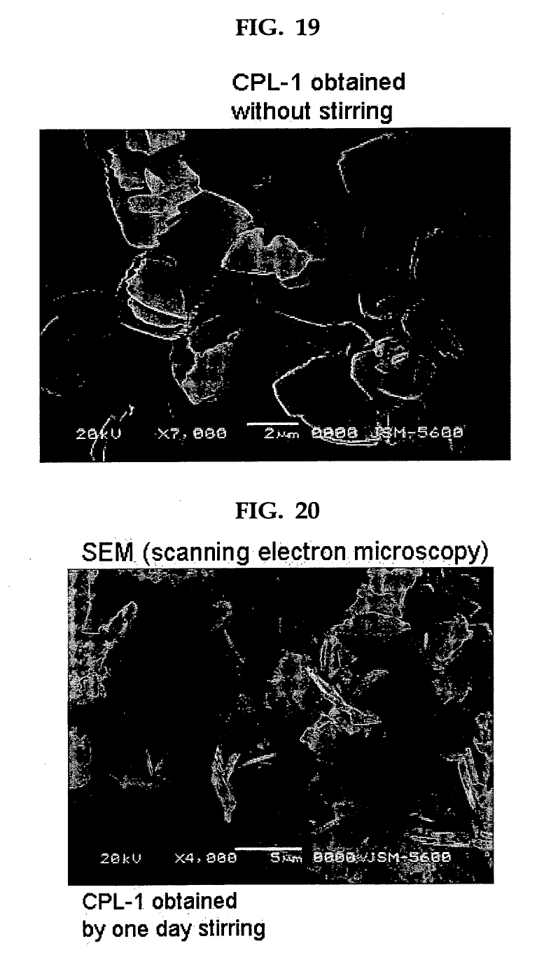

FIG. 19 is a SEM electron microscope photograph (Magnification: 7,000) of the crystal of the organometallic complex structure obtained in the case where the amount of the poly(vinylsulfonic acid, sodium salt) (PVSA), as the organic polymer, added to the metal ion was 0 equivalent (Comparative Example).

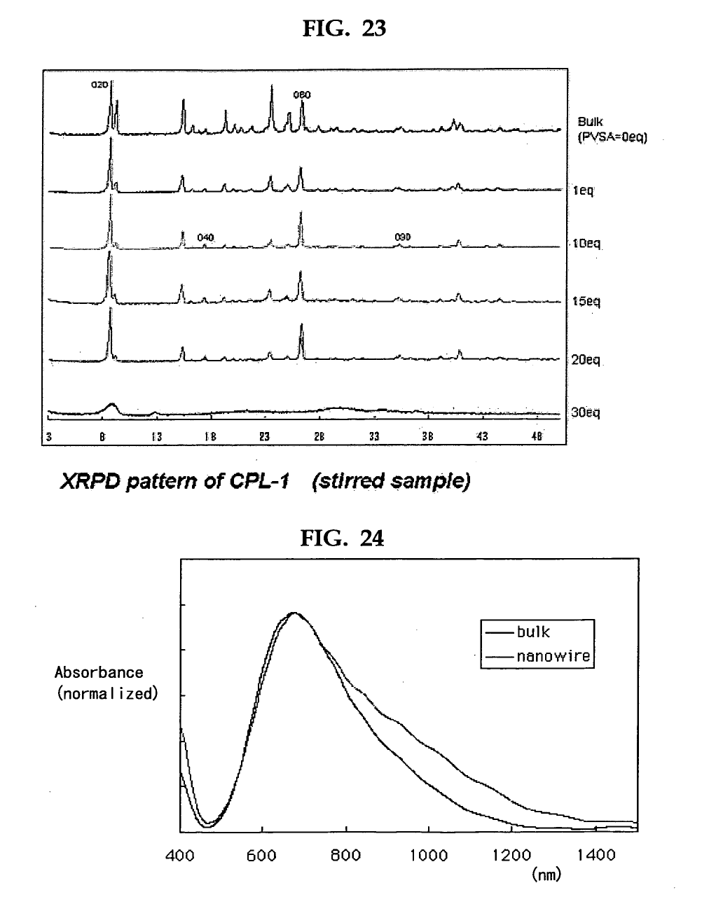

FIG. 23 is a result of the analysis in which the differences of the crystalline properties of organometallic complex structures were compared by analyzing XRPD patterns. The amount of poly(vinylsulfonic acid, sodium salt) (PVSA) as the organic polymer to be added to the metal ion was changed (0 equivalent, 1 equivalent, 10 equivalent, 15 equivalent, 20 equivalent, 30 equivalent) and each organometallic complex structure was obtained after the mixing with stirring for one day. The values on the right side in FIG. 23 mean the added amount. The cases where the added amount of the poly(vinylsulfonic acid, sodium salt) (PVSA) is 1 equivalent, 10 equivalent, 15 equivalent, 20 equivalent, and 30 equivalent correspond to Examples of the invention, and the case of 0 equivalent corresponds to Comparative Example of the invention.

In the chart of XRPD pattern, if peak of 0k0 is emphasized and other peaks become smaller, it means that the orientation of the pores in the crystal faces in a certain direction.

FIG. 20 is a SEM electron microscope photograph (Magnification: 4,000) of the crystal of the organometallic complex structure obtained after mixing with stirring for one day, wherein the added amount of the poly(vinylsulfonic acid, sodium salt) (PVSA) as the organic polymer to the metal ion was 0 equivalent (Comparative Example).

FIG. 24 is a result of the analysis in which the crystal of organometallic complex structure was analyzed by a near-infrared absorption spectral pattern. Pyrazine (pyz) as the pillar ligand was changed to bipyridine (bpy), and the amount of poly(vinylsulfonic acid, sodium salt) (PVSA), as the organic polymer, added to the metal ion was changed (50 equivalent). After the mixing with stirring for one day, a slight pressure was applied to the obtained crystals of organometallic complex structure with a hand from above.

FIG. 25 is a result of the analysis of powder X-ray diffraction pattern of the crystal of the same organometallic complex structure. In the lower chart of FIG. 25 (the case where a slight pressure was applied to the obtained crystals of organometallic complex structure with a hand from above), peak of 0k0 is emphasized, meaning that the orientation of the pores in the crystal faces in a certain direction.

FIG. 13 is a SEM electron microscope photograph (Magnification: 1,500) of the crystal of the same organometallic complex structure and FIG. 14 is a TEM electron micrograph of the crystal of the same organometallic complex structure. The poly(vinylsulfonic acid, sodium salt) (PVSA) was added and mixed with stirring. Then, wire-like crystals were obtained. Since crystal growth of this wire-like crystal is anisotropic, its near-infrared absorption spectral pattern was different from that of bulk crystal obtained without adding the poly(vinylsulfonic acid, sodium salt) (PVSA) (See FIG. 24). In addition, the XRPD pattern of this wire-like crystal was different from that of bulk crystal obtained without adding the poly(vinylsulfonic acid, sodium salt) (PVSA) (lower graph in FIG. 25), and this wire-like crystal exhibits a preferential orientation that it is easily oriented along a plane.

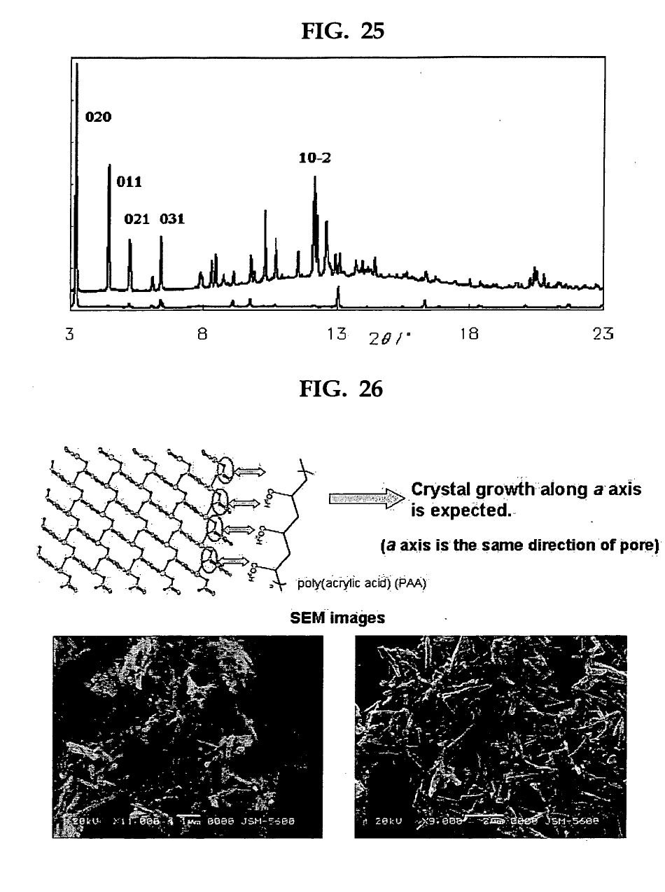

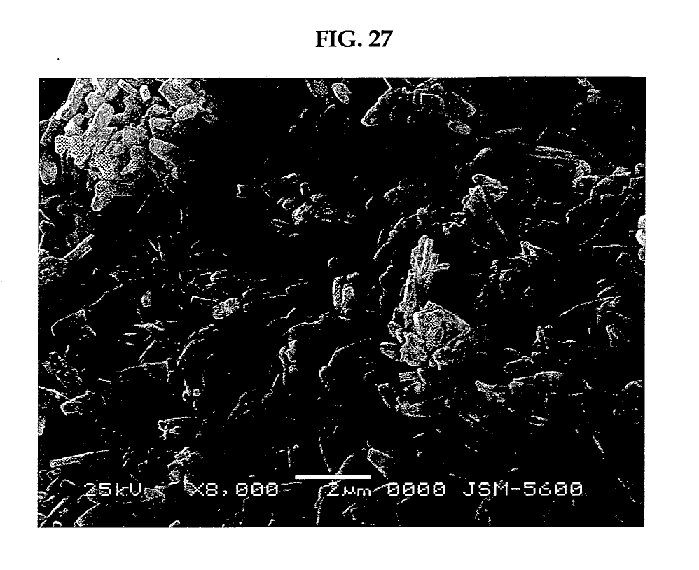

FIG. 26 is SEM electron microscope photographs (magnification of left photograph: 11,000 and magnification of right photograph: 9,000) of the crystal of the wire-like organometallic complex structure obtained when 20 equivalent poly(vinylsulfonic acid, sodium salt) (PVSA) as the organic polymer was added to the metal ion. FIG. 27 is SEM electron microscope photographs (Magnification: 8,000) of the crystal of the wire-like organometallic complex structure obtained when 10 equivalent poly(vinylsulfonic acid, sodium salt) (PVSA) as the organic polymer was added to the metal ion. These SEM electron microscope photographs indicate that if the added amount of the poly(vinylsulfonic acid, sodium salt) (PVSA) as the organic polymer to the metal ion is 20 equivalent or more, crystals of wire-like organometallic complex structure are obtained.

The invention can solve conventional problems and can provide an organometallic complex structure which can be appropriately utilized as e.g. a novel material, composite material, membrane, and structure in a variety of regions such as electronics, magnetics, adsorption, catalyst, luminescence, medicine, carrier, and analysis, which guest can be, for example, adsorbed to, desorbed from, or arranged in effectively or selectively, and which is extremely highly functional without the structure being destroyed during performing such functions, and efficient production method thereof that can control its crystalline properties (size, dimension, etc.) easily; and to provide a functional film, functional composite material, functional structure that can be appropriately utilized in a variety of regions such as electronics, magnetics, adsorption, catalyst, luminescence, medicine, carrier, and analysis by using the organometallic complex structure and that are highly functional and/or high performance, and a adsorption and desorption sensor by which detection or analysis is possible at a molecular level and that is high-performance.

### INDUSTRIAL APPLICABILITY

The organometallic complex structure of the invention can be appropriately utilized as e.g. a novel material, composite material, membrane, structure in a variety of regions such as electronics, magnetics, adsorption, catalyst, luminescence, medicine, carrier, and analysis, and as a detecting unit such as a sensor.

The method for producing an organometallic complex structure of the invention can be appropriately utilized for producing the organometallic complex structure of the invention efficiently while controlling its crystalline properties (size, dimension, etc.).

The functional film, functional composite material, or functional structure of the invention can be appropriately utilized as e.g. a novel material, composite material, membrane, structure in a variety of regions such as electronics, magnetics, adsorption, catalyst, luminescence, medicine, carrier, and analysis, and as an adsorbing unit of guest (target), arranging unit of guest (target), detecting unit such as a sensor.

The adsorption and desorption sensor of the invention can be appropriately utilized for the analysis of guest (target) at a molecular level, for example, as a device for gas detection, impurity detection, toxic molecule detection, or diagnosis.

1. An organometallic complex structure comprising:
a metal ion;
an organic compound capable of binding to the metal ion;
a pillar ligand capable of binding to the metal ion; and
an organic polymer capable of interacting with the metal ion; wherein the organometallic complex structure has a porous structure.

2. The organometallic complex structure according to claim 1, wherein the molar ratio of the metal ion, the organic compound, and the pillar ligand, that is, metal ion:organic compound:pillar ligand, is one of 2:2:1 and 1:2:1.

3. The organometallic complex structure according to claim 1, wherein the organometallic complex structure is expressed by one of formulae: {[M₂Y₂L]₂×xH₂O}ₙ and {[MY₂L]₂·xH₂O}ₙ, where M represents the metal ion, Y represents the organic compound, L represents the pillar ligand, and x and n represent an integer.

4. The organometallic complex structure according to claim 1, wherein the porous structure is a structure such that pores with a specific size are arrayed regularly.

5. The organometallic complex structure according to claim 1, wherein the porous structure is a structure such that two organometallic layers adjacent to each other of two or more organometallic layers formed by the metal ion and the organic compound are linked by the pillar ligands, wherein the pillar ligands are arranged with the length direction thereof being a substantially same direction and spaced substantially at specific intervals.

6. The organometallic complex structure according to claim 5, wherein in the porous structure, a plurality of pores have a substantially specific size seen from the direction substantially parallel to the arrayed direction of the pillar ligands, wherein the pore is formed by two pillar ligands adjacent to each other, two another pillar ligands adjacent to the two pillar ligands and positioned substantially in parallel thereto, and a region of the organometallic layer, the region being surround by these four pillar ligands.

7. The organometallic complex structure according to claim 1, wherein in the porous structure, the size of the pores is capable of being changed by a stimulus.

8. The organometallic complex structure according to claim 4, wherein the organometallic layer comprises a structure in which organometallic layer structural units formed by the metal ion and the organic compound are bridged, wherein in the organometallic layer, each of metal ions in two organometallic layer structural units is bridged by an organic compound of one organometallic layer structural unit and an organic compound of the other organometallic layer structural unit, the one and the other organometallic layer structural units each being different from the two organometallic layer structural units, to thereby form a metal ion dimmer dimer unit.

9. The organometallic complex structure according to claim 8, wherein the orientation of a pillar ligand along the length direction, the pillar ligand being bound to one metal ion in the metal ion dimer unit of the organometallic layer and the orientation of a pillar ligand along the length direction, the pillar ligand being bound to the other metal ion are different from each other.

10. The organometallic complex structure according to claim 1, wherein the metal ion is selected from Group 6 element to Group 12 element in the long form of a periodic table.

11. The organometallic complex structure according to claim 1, wherein the metal ion is a divalent atom.

12. The organometallic complex structure according to claim 1, wherein the metal ion is selected from a copper ion, a rhodium ion, a chromium ion, a molybdenum ion, a palladium ion and a zinc ion.

13. The organometallic complex structure according to claim 1, wherein the organic compound is a bridging ligand capable of bridging to the metal ion.

14. The organometallic complex structure according to claim 1, wherein the organic compound is selected from a heteroaromatic compound and a derivative thereof.

15. The organometallic complex structure according to claim 1, wherein the organic compound is pyrazine-2,3-dicarboxylate.

16. The organometallic complex structure according to claim 1, wherein the affinities of the organic compound and the pillar ligand are selected from hydrophilic and hydrophobic.

17. The organometallic complex structure according to claim 1, wherein the affinity of the organic compound and the pillar ligand is one of hydrophilic and hydrophobic to each other.

18. The organometallic complex structure according to claim 1, wherein the pillar ligand comprises a heteroaromatic compound.

19. The organometallic complex structure according to claim 1, wherein the pillar ligand comprises heteroatoms at both ends thereof.

20. The organometallic complex structure according to claim 1, wherein the pillar ligand is selected from pyrazine, bipyridine, azopyridine, dipyridylethylene, dipyridylbenzene, dipyridylglycol, dipyridylethane and dipyridylpropane.

21. The organometallic complex structure according to claim 1, wherein the pillar ligand is at least one of capable of being expanded and contracted, and capable of being transformed.

22. The organometallic complex structure according to claim 1, wherein the pillar ligand is at least one of capable of being expanded and contracted by a stimulus, and capable of being transformed by a stimulus.

23. The organometallic complex molecule according to claim 1, wherein the pillar ligand comprises two or more organic molecules, wherein at least two organic molecules of the two or more organic molecules interact with each other through π-π stacking.

24. The organometallic complex structure according to claim 1, wherein the organic polymer is selected from an ionic polymer.

25. The organometallic complex structure according to claim 24, wherein the ionic polymer is selected from a cationic polymer, an anionic polymer and an amphoteric polymer.

26. The organometallic complex structure according to claim 24, wherein the ionic polymer is polyvinylsulfonic acid, sodium salt.

27. The organometallic complex structure according to claim 1, which is one of a plate-like crystal, a granular crystal, and a wire-like crystal.

28. The organometallic complex structure according to claim 1, which is used for at least one of adsorption and desorption of a guest, and arrangement of a guest.

29. The organometallic complex structure according to claim 1, which is used for at least one of selective adsorption and desorption of a guest, and selective arrangement of a guest.

30. A functional film comprising an organometallic complex structure,
wherein the organometallic complex structure comprises:
a metal ion;
an organic compound capable of binding to the metal ion;
a pillar ligand capable of binding to the metal ion; and
an organic polymer capable of interacting with the metal ion,
wherein the organometallic complex structure has a porous structure.

31. A functional composite material comprising:
an organometallic complex structure; and
a guest,
wherein the guest is one of adsorbed to and arranged in pores of the organometallic complex structure, and
wherein the organometallic complex structure comprises:
a metal ion;
an organic compound capable of binding to the metal ion;
a pillar ligand capable of binding to the metal ion: and
an organic polymer capable of interacting with the metal ion,
wherein the organometallic complex structure has a porous structure.

32. A functional structure comprising:
a substrate; and
an organometallic complex structure of,
wherein the organometallic complex structure comprises:
a metal ion;
an organic compound capable of binding to the metal ion;
a pillar ligand capable of binding to the metal ion: and
an organic polymer capable of interacting with the metal ion,
wherein the organometallic complex structure has a porous structure.

33. The functional structure according to claim 32, further comprising a guest,
wherein the guest is one of adsorbed to and arranged in pores of the organometallic complex structure.

34. A adsorption and desorption sensor comprising:
an organometallic complex structure; and
a detecting unit configured to detect at least one of adsorption of a guest to and desorption of the guest from pores of the organometallic complex structure,
wherein the organometallic complex structure comprises:
a metal ion;
an organic compound capable of binding to the metal ion;
a pillar ligand capable of binding to the metal ion; and
an organic polymer capable of interacting with the metal ion,
wherein the organometallic complex structure has a porous structure.

35. A method for producing an organometallic complex structure, comprising:
mixing a metal ion, an organic compound capable of binding to the metal ion, a pillar ligand capable of binding to the metal ion, and an organic polymer capable of interacting with the metal ion.

36. The method for producing an organometallic complex structure according to claim 35, wherein the mixing is carried out at temperatures of 50° C. or lower.

37. The method for producing an organometallic complex structure according to claim 35, wherein the amount of organic molecules to be mixed at the mixing satisfies: (mole of the organic molecules/mole of the metal atom)≧20.

38. The method for producing an organometallic complex structure according to claim 35, wherein the mixing is carried out by stirring.

39. The method for producing an organometallic complex structure according to claim 35, wherein after the mixing, an obtained crystal or a powder is subjected to a selective orientation treatment, wherein in the selective orientation treatment, pressure is applied to the obtained crystal or the powder from one direction.

40. The method for producing an organometallic complex structure according to claim 35, wherein after the mixing, an obtained crystal or a powder is subjected to a selective orientation treatment, wherein in the selective orientation treatment, pressure is applied to the obtained crystal or the powder by pushing the obtained crystal or the powder with fingers from one direction.

41. The method for producing an organometallic complex structure according to claim 35, wherein the metal ion is mixed as a compound containing the metal ion.
